(19) United States
(12) Patent Application Publication
(10) Pub. No.: US 2025/0298666 A1
(43) Pub. Date: Sep. 25, 2025

(54) Dynamic Processing Pipeline for Models on Nodes of A Network

(71) Applicant: TurbineOne, Inc., San Francisco, CA (US)

(72) Inventors: Matthew Warren Amacker, Santa Clara, CA (US); Keith Joseph Goldberg, Winter Park, FL (US); Charles R. Barker, JR., Orlando, FL (US); Tyler Moore, Colorado Springs, CO (US); Joshua Harrison, Boulder, CO (US)

(21) Appl. No.: 19/084,337

(22) Filed: Mar. 19, 2025

Related U.S. Application Data
(60) Provisional application No. 63/567,832, filed on Mar. 20, 2024.
(60) Provisional application No. 63/761,669, filed on Feb. 21, 2025.

(51) Int. Cl. G06F 9/50

(52) U.S. Cl. CPC G06F 9/5027

(57) ABSTRACT

Embodiments may relate to dynamic processing pipelines that include multiple models communicatively coupled together (e.g., in series) to accomplish a task. Each model in a pipeline may be configured (e.g., trained or machine learned) for a specific task. For example, a first model in a pipeline may be trained to identify humans in images and a second model in the pipeline may be trained to detect furniture in images. The models may be stored on nodes of a network (e.g., an ad-hoc, peer-to-peer, and/or mesh network). The pipeline may be implemented by nodes of the pipeline applying received data to their corresponding models and then transmitting output data to the next node in the pipeline. Embodiments may relate to a graphical user interface (GUI) for viewing or filtering data of the pipeline according to one or more user-defined alert filters.

### CROSS REFERENCE TO RELATED APPLICATIONS

This application claims the benefit of, and priority to, U.S. Provisional Application No. 63/567,832, titled “Dynamic Processing Pipeline for Models on Nodes of A Network” and filed Mar. 20, 2024, and U.S. Provisional Application No. 63/761,669, titled “Alerting Through Multiple User-Configurable Tabs” and filed Feb. 21, 2025, each of which is incorporated herein by reference in its entirety.

### BACKGROUND

Models (e.g., classification models or detection models) can be configured (e.g., trained) to perform specific or general tasks. Models configured for specific tasks can be useful when applied to those specific tasks. However, those models can be problematic if applied to other tasks. Similarly, general models can be applied to a variety of different tasks. However, those general models can have high noise or error rates when applied to specific tasks.

### BRIEF DESCRIPTION OF THE DRAWINGS

FIG. 1 is a block diagram of a system environment for a squad of nodes, according to one or more embodiments.

FIG. 2 is a block diagram of a node, according to one or more embodiments.

FIG. 3 is an illustration of a discovery interval data structure, according to one or more embodiments.

FIG. 4 is an illustration of a state diagram of a node 110 executing a discovery and synchronization protocol, according to one or more embodiments.

FIG. 5 illustrates a diagram of bootstrapping a node into a squad, according to one or more embodiments.

FIG. 6 illustrates a diagram of merging squads, according to one or more embodiments.

FIG. 7 illustrates a diagram of changing an existing node's node information, according to one or more embodiments.

FIG. 8 illustrates a diagram of removing a node from a current node list, according to one or more embodiments.

FIG. 9A illustrates a method of synchronization of nodes performed using instructions of synchronization request module 251, according to one or more embodiments.

FIG. 9B illustrates a method of synchronization of nodes performed using instructions of multicast beaconing module 252, according to one or more embodiments.

FIG. 10 illustrates a method of pruning a node list for a squad, according to one or more embodiments.

FIG. 11 is a block diagram of an example pipeline, according to one or more embodiments.

FIG. 12A is a diagram of an example network that implements the pipeline of FIG. 11, according to one or more embodiments.

FIG. 12B illustrates a method of generating a pipeline according to a pipeline recipe.

FIG. 13 is a diagram of a graphical user interface (GUI) including a user-configurable tab for setting user-defined alert filters, according to an embodiment.

FIG. 14 is a diagram of a GUI including a plurality of user-configurable tabs for setting user-defined alert filters, according to one or more embodiments.

FIG. 15 is a block diagram illustrating components of an example machine able to read instructions from a machine-readable medium and execute them in a processor (or controller), according to one or more embodiments.

The FIGURES depict various embodiments for purposes of illustration only. One skilled in the art will readily recognize from the following discussion that alternative embodiments of the structures and methods illustrated herein may be employed without departing from the principles described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### CONFIGURATION OVERVIEW

Models (e.g., classification models or detection models) can be configured (e.g., trained) to perform specific or general tasks. Models configured for specific tasks can be useful when applied to those specific tasks. However, those models can be problematic if applied to other tasks. Similarly, general models can be applied to a variety of different tasks. However, those general models can have high noise or error rates when applied to specific tasks.

A data processing pipeline can combine multiple models configured to receive data from each other, each model configured for a specific task. The models may be instantiated on nodes of a network (e.g., a plurality of computing devices), and the pipeline implemented according to a pipeline recipe by nodes applying received data to their corresponding models and transmitting output data to subsequent node(s).

Various embodiments described herein relate to dynamic processing pipelines that include multiple models communicatively coupled (e.g., connected) together (e.g., in series) to accomplish a task. Each model in a pipeline is configured (e.g., trained or machine learned) for a specific task. For example, a first model in a pipeline is trained to identify humans in images and a second model in the pipeline is trained to detect furniture in images. The models are stored on nodes (e.g., mobile nodes or stationary nodes) of a network (e.g., an ad-hoc, peer-to-peer, and/or mesh network). The pipeline is implemented by nodes of the pipeline applying received data to their corresponding models and then transmitting output data to the next node in the pipeline.

Some embodiments described herein relate to setting alert thresholds for one or more models in a pipeline. For example, when an object detection model (ODM) has a positive object detection, the pipeline can generate an alert. Users may group certain alerts together by setting one or more alert thresholds or filters. Users can create multiple “tabs” in a graphical user interface (GUI) to view user-defined alert groups and test various alert thresholds. When a user creates a new tab which defines one or more alert criteria (e.g., “object detections for which the target object has moved at least one kilometer”), a system can apply an alert filter based on the alert criteria to previous output data of the pipeline (e.g., object detection data) to display relevant alerts in an alert group under the new tab. The user can create additional tabs having different alert thresholds or filters to quickly compare alert groups and gain a new perspective on the detection data.

### INTRODUCTION

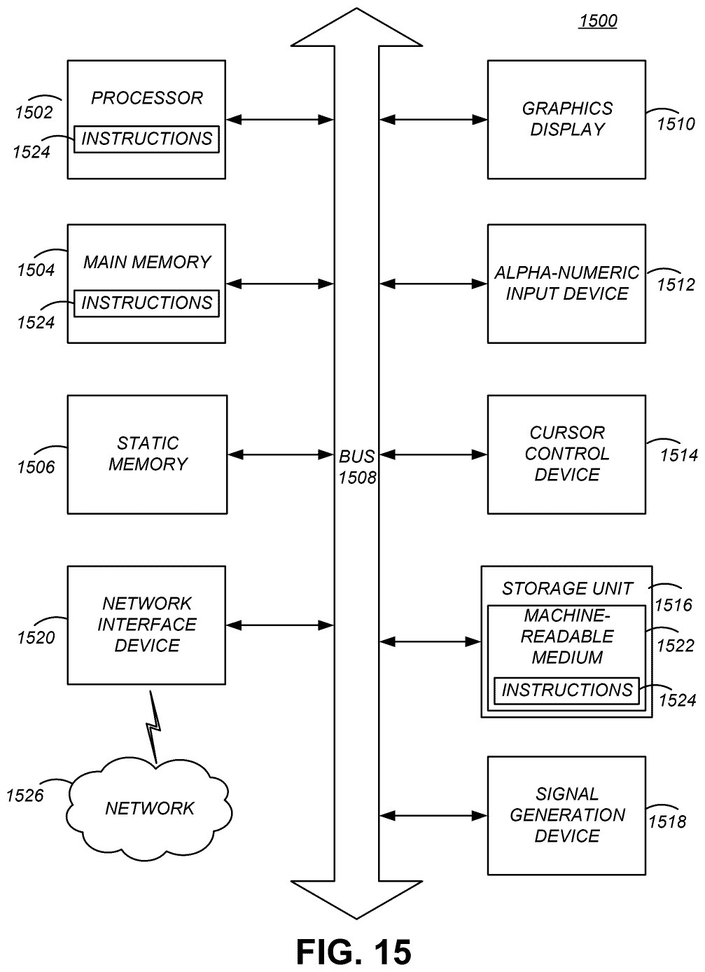

As used herein, a node may refer to a computer, such as computer system 1500 described with respect to FIG. 15. In some embodiments, a node is a computing device configured into an ad-hoc network, such as a mesh network or other peer-to-peer (P2P) network. As used herein, an “ad-hoc network” may refer to a computer network that can be spontaneously formed when computing devices communicate with one another. For example, an “ad-hoc network” can be a local area network that forms temporarily or that changes its topology as computing device move in and out of range of the network. Nodes may include mobile devices such as on body computing devices, remote controllers, autonomous machines (such as robot or drones), notebook computers, smartphones, personal digital assistants, tablets, and the like. On-body computing devices may be wearable computing devices that provide automatic and persistent perception capabilities to the wearer. An on-body computing device may be a specialized computing device. A specialized computing device may have particular functionality. For example, the specialized computing device may be a sensor to sense immediate physical environmental parameters or physiological parameters of a wearer. The specialized computing device also may be function specific, for example, visual processing, audio processing, communications capabilities or other specialized functions. Moreover, the specialized computing devices may have limited processing and power capabilities, for example, to curtain need for larger power supplies and/or keep device as light as possible. Nodes may include stationary computing devices, such as desktop computers, servers, storage devices, routers, switches, or any other stationary computing device known to those skilled in the art.

In one embodiment, a grouping of nodes into an ad-hoc network may be referenced as a squad. The nodes forming the squad may be configured to accomplish a specific action (e.g., task) or set of actions (e.g., to form a mission). For example, a squad may include a mesh network of nodes that work cooperatively to accomplish a mission or other tasks. The node may also handle communication, data update, and network resilience amongst specialized computing devices of the squad. In some embodiments, two or more squads may be networked together, e.g., via a communications bridge.

On body computing devices may be configured to provide the wearer with perception capabilities that would not be feasible for the wearer to perform on their own. For example, the on body computing device may augment visual perception by providing facial recognition capabilities to match the appearance of persons in the vicinity of the wearer against a database of persons of interest. Moreover, the on body computing device may provide information about identified persons of interest that may aid the wearer on how to handle an interaction with the person of interest. In another example, the on body computing device may provide enhanced perception capabilities, such as providing perception capabilities across all directions (e.g., front, back, and sides) of the wearer, in addition to providing perception capabilities across an expanded field by crowdsourcing the analysis of the expanded field across multiple nodes of a squad.

On body computing devices may be worn by members of a team traversing across a geographical area (e.g., a geographically bounded area). For example, on body computing devices may be worn by members of a search team searching for a person across a geographical area. The on body computing devices may provide enhanced perception capabilities and enhanced communication capabilities to the members of the search team to be able to find the target more easily. In another example, on body computing devices may be worn by soldiers of a squad to provide enhanced perception capabilities and enhanced communication capabilities to obtain information about the state of the battlefield.

In one embodiment, as noted above, a mobile node, such as an on-body computing device may include a set of sensors for enhancing the perception of the wearer (stationary nodes may also include sensors). For example, the mobile node includes one or more cameras for capturing images or videos of the surroundings of the mobile node, and an array of microphones for capturing audio of the surroundings of the mobile node. Moreover, the mobile node may include additional sensors such as temperature sensors, proximity sensors, light sensors, gas sensors, etc. The data captured by the sensors may then be analyzed by one or more classification models (e.g., image classification models such as a person of interest detection model) run by the mobile node. Furthermore, the output of the classification model may be displayed to the wearer of the mobile node (e.g., though a head mounted display), and/or may be provided to other nodes of the squad.

In one embodiment, a node includes a set of network adapters for establishing a mesh network to communicate with other members of the squad. For example, the node may include a first network adapter that is configured to act as an access point that accepts connections from other members of the squad. The node may include a second network adapter that is configured to search for access points corresponding to other members of the squad and is configured to connect to one or more access points.

In one embodiment, nodes are configured to communicate among themselves to distribute the workload of executing resource intensive tasks. Specifically, the computational capabilities of wearable devices may be limited to improve the portability or wearability of the device. For example, the size of a battery used to power the wearable device is typically limited so as to not significantly impair the mobility of the wearer, and the computational power of the wearable device is typically limited to improve the battery life of the device. By spreading the workload of resource intensive tasks across multiple nodes, the completion of the resource intensive task may be accelerated.

### System Architecture

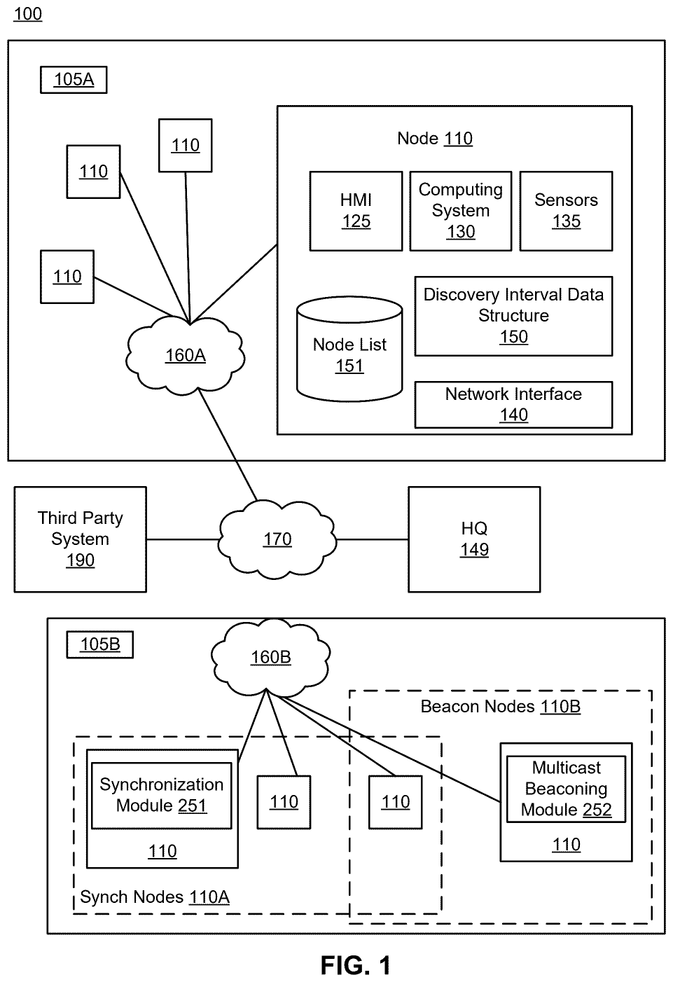

Figure (FIG. 1 is a block diagram of a system environment 100 for a squad 105 of nodes 110, according to one or more example embodiments. The system environment 100 shown by FIG. 1 comprises one or more squads 105 (e.g., first squad 105A and second squad 105B), a headquarter (HQ) node 149, and a cloud network 170. In some embodiments, the system environment 100 additionally includes one or more third-party systems 190. In alternative configurations, different and/or additional components may be included in the system environment 100.

The squad 105 comprises one or more mobile nodes or stationary nodes 110 (also referred to herein as “nodes 110”) that are communicatively coupled with each other through a peer-to-peer (P2P or p2p) network 160, which in some embodiments may be include one or more mesh networks. For instance, the diagram illustrated in FIG. 1 includes two squads 105A and 105B. The first squad 105A may include a first set of nodes 110 connected to each other through a first mesh network 160A. The second quad 105B may include a second set of nodes 110 connected to each other through a second mesh network 160B.

The nodes 110 are computing devices capable of receiving user input as well as transmitting and/or receiving data via the p2p network 160 or the cloud network 170. In one embodiment, a mobile node 110 is an on-body node or a wearable node. An on-body node or a wearable node is a computer system implemented in an enclosure that can be worn by a person. Alternatively, the mobile node 110 may be a device having computer functionality, such as a personal digital assistant (PDA), a mobile telephone, a smartphone, or another suitable device that is portable and can be carried by a person. In yet other embodiments, the mobile node 110 is a computing device embedded or attached to remote controlled or autonomous machines (such as drones).

The node 110 may be configured to communicate with other nodes within the squad 105 via the p2p network 160. The p2p network may be created by establishing node to node connections between two or more nodes of the squad. In some embodiments, a node 110 is able to communicate with other nodes that are connected to the p2p network 160 but not directly connected to the node via an intermediary node or a chain of intermediary nodes. Moreover, a node 110 may be configured to communicate (e.g., to devices outside of the squad 105) via the cloud network 170. In some embodiments, the nodes 110 of a squad is able to connect to the cloud network 170 as long as at least one node has a connection to both the cloud network 170 and the p2p network 160 of the squad. In some embodiments, a squad may not have a connection to the cloud network 170. For instance, the second squad 105B of FIG. 1 has a set of nodes 110 that are connected to each other but that do not have a connection to the cloud network 170. In this example, none of the nodes of the squad 105B may be within range of an access point for connecting to the cloud network 170.

In one embodiment, the node 110 executes an application for presenting information to a user of the node 110. Additionally, a node 110 may execute an application allowing a user of the node 110 to interact with the other nodes 110, the HQ node 149, or the one or more third-party systems 190. For example, a node 110 executes classification models to present information corresponding to the environment surrounding the user of the node 110. In another example, the node 110 receives executes a communication application for receiving or transmitting information from other nodes 110 corresponding to the environment surrounding to users of the other nodes 110, or executes a work-sharing application for sharing computational power with other nodes 110 for analyzing the environment surrounding the node 110 or the environment surrounding the other nodes 110.

Each node 110 may include a human-machine interface (HMI) 125, one or more computing system 130, a set of sensors 135, a discovery interval data structure 150, a node list 151, and one or more network interfaces 140. In embodiments, the node list 151 may be implemented as a distributed database that is maintained and distributed across the nodes 110 of a squad 105.

The HMI 125 includes input and output devices. The HMI 125 is configured to receive information from the system environment 100 of the mobile node 110 or the computing system 130, and control and output device for presenting the received information or otherwise providing a stimulus based on the received information to the user of the node 110. For example, the HMI includes a display for presenting a graphical user interface (GUI) to the user of the node 110. The display may be a head-mounted display (HMD) such as a helmet with an eye shield. Alternatively, the display may be a display device embedded in the computing system 130 (e.g., a display of a smartphone). In some embodiments, the HMI includes multiple displays for presenting different pieces of information to the user of the node 110. The GUI may be configured to present visual notifications to the user of the node 110. In some embodiments, the GUI for displaying information to the user of the node 110 is generated or rendered by the computing system 130, or a separate processor embedded in the HMI 125. In some embodiments, the HMI includes other output devices such as speakers or headphones for providing audible cues or notification (e.g., beeps, buzzes, etc.), haptic devices for providing haptic cues (e.g., vibrations), light sources (such as strobe lights), heat sources, etc.

Moreover, the HMI 125 is configured to receive inputs from a user of the node 110 and provide signals to the computing system 130 of the node 110 for processing. For example, the HMI includes a microphone (e.g., for receiving voice inputs), a camera (e.g., for receiving gesture inputs), one or more buttons (e.g., as part of a keyboard and/or keypad), a touch screen, a pointing device, accelerometers, etc. In some embodiments one or more input devices of the HMI are embedded devices of the computing system (e.g., a microphone and touch screen of a mobile smartphone).

The computing system 130 is configured to perform computational tasks, e.g., communications, data processing, or tracking. In some embodiments, the computing system 130 receives a set of inputs (such as video input recorded by a camera or audio input recorded by a microphone) and processes the inputs based on predefined tasks. Moreover, the computing system 130 may perform additional tasks as requested by the operator of the node 110, or as requested by other nodes 110 or the HQ node 149 communicating through the network. In some embodiments, the computing system 130 includes a mobile smartphone or other mobile computing devices. An example of a computing system 130 that can be used in a node 110 is provided below in conjunction with FIG. 15.

The sensors 135 are configured to capture data of the surroundings of the node 110. For example, the node 110 may include one or more (e.g., an array) cameras for capturing images or videos of the surroundings of the node 110. The images or videos captured by the one or more cameras may be sent to classification models being run by the computing system 130 to identify conditions of the surroundings of the node 110, including the recognition of object and individuals in the vicinity of the node 110. Moreover, the node 110 may include one or more (e.g., an array) microphones for capturing audio of the surroundings of the node 110. The audio being captured by the array of microphones may be sent (e.g., transmitted) to classification models to identify conditions of the surroundings of the node 110, including the triangulation of specific audio cues to identify the direction or location the audio cues originated from. In some embodiments, the sensors 135 include additional sensors, e.g., temperature sensors, pressure sensors, proximity sensors, light sensors, and/or gas sensors.

In some embodiments, one or more (e.g., an array) sensors 135 are connected to the computing system 130 and provide the data captured by the sensors to the computing system 130. Alternatively, one or more sensors 135 may be connected to other components of the node 110 through the network interface 140. For example, the sensors may have a wireless network adapter and my register with the network interface 140 during a boot (e.g., system startup) process. Each sensor may have a specific address or port number and other components of the node 110 (and optionally other nodes of the squad) are able to request data from each of the sensors by transmitting requests to the address or port number assigned to the corresponding sensor.

The discovery interval data structure 150 stores data relating to a discovery interval configured for a squad. As used herein, a “discovery interval” may refer to one or more predefined time that establish when actions are expected of each node 110 participating in the synchronization protocol. For example, the discovery interval may be a set time limit for when nodes 110 in a squad 105 will wait to perform a follow-up action after an action that was previously performed, such as the transmitting or receiving of a message. In embodiments, the discovery interval is configured according to the discovery interval data structure 150. Each node 110 in a squad 105 stores the discovery interval data structure 150. The discovery interval structure 150 includes time slots that may each be assigned to a particular node 110 in the squad 105. Each time slot may operate according to a set timer that will initiate the next action upon expiration. In embodiments, the time slots may be divided into two separate pools. The first pool of time slots may be reserved for nodes 110A (also referred to herein as “synch nodes” 110A) that are expected, assigned, or desiring to transmit a unicast synchronization request. As used herein, a “synch node” may refer to a node that is configured to, during some period of time (e.g., during an allotted time slot in a synchronization window), transmit a unicast synchronization request. The second pool of time slots may be reserved for nodes 110B (also referred to herein as “beacon nodes” 110B) that are expected, assigned, or desiring to transmit a multicast beacon. As used herein, a “beacon node” may refer to a node that is configured to, during some period of time (e.g., during an allotted time slot in a beacon window), transmit a multicast beacon. In one embodiment, each time slot in the discovery interval structure 150 may be of a predefined constant time. For example, the duration of time allotted for each time slot may be a fixed constant calculated based on expected or average propagation delays experienced by the p2p network 160. The propagation delay for the p2p network 160 may depend on the radio technology, mesh protocol optimizations, the size, shape, and density of the network mesh, other mesh or network characteristics, or some combination thereof. In one embodiment, each time slot may be configured according to a worst-case, end-to-end propagation delay across the p2p network 160.

The node list 151 delineates and describes each node 110 in the squad and its characteristics and other information. The node list 151 comprises the list of nodes 110 in the squad 105 and node information for each of the nodes 110. Each node 110 maintains its own copy of the node list 151. At any given time, a node's stored node list may vary from another node's stored node list in the squad 105, as a result of adding or missing information. As used herein, a “stored node list” refers to a node list 151 that is locally stored on a node 110 and that can be compared to a node list 151 received in a message. Each node 110 in the node list may be identified by an address (e.g., network address or node location) and/or name (e.g., hostname or other recognizable name). In embodiments, node information for each node may include a service address (e.g., RPC Service IP Address or other service IP address, such as v6 or v4), node name (e.g., hostname, name intended for human readability in a user interface and/or network logs), characteristics of the node 110, other information relating to a node 110, or some combination thereof. In embodiments, characteristics of a node 110 may include services offered by the node 110, status of the node 110, computational state of the node 110, power state of the node 110, other informative description about the node 110 and its capabilities, or some combination thereof. Some non-limiting services offered by a node 110 may include machine learning capabilities, camera or other sensor capabilities, alert capabilities, other services or capabilities, or some combination thereof. As such, in embodiments, the node information for a node 110 may include identifiers that uniquely identify or classify a particular machine learning (ML) agent running on the node 110, a particular camera/sensor or particular camera/sensor system operating on the node 110 (e.g., sensor 135), a particular type of alert delivered by the node 110, a particular consumer, user, or wearer of the node 110, other identifier or classification of a node service, or some combination thereof.

In embodiments, each node maintains the node list 151 (e.g., stored node list) identifying the currently known nodes 110 that are known to itself, including itself (e.g., the list of names or other unique identifier for each node 110 in the squad and its own name or unique identifier). In embodiments, the node list 151 may be maintained and sorted according to a set order, such as being sorted according to an internet protocol (IP) address or other unique identifier or network address. As such, when the node list 151 stored on one node 110 matches the information in the node list 151 stored on another node 110 (e.g., contains the same node information without any new or missing information), the hash of each node list 151 will also match. Furthermore, having an ordered node list 151 also gives each node 110 a way to compute a timer offset. In one embodiment, the timer offset of a node 110 is computed as the position of the node 110 in the node list 151 multiplied by the base propagation delay for the p2p network 160. As such, the timer offset reduces the likelihood of overlapping transmissions between each node 110 in the squad 105.

The network interface 140 is configured to receive and transmit information from network interfaces of other nodes 110 and the HQ node 149. In some embodiments, the network interface 140 is configured to receive information (such as data packets) from other components of the node 110 (such as the computing system 130) and emit electromagnetic signals generated based on the received information. Moreover, the network interface 140 is configured to capture electromagnetic signals emitted by a network interface of another node 110 and generate signals to provide to other components of the node 110 (such as the computing system 130) for processing. In some embodiments, the network interface 140 includes one or more (e.g., an array) antennas to transmit and receive electromagnetic signals (wireless signals). Moreover, each node 110 may include multiple network interfaces 140. For example, each node may have a primary network interface for connecting to a primary network, and a secondary network interface for connecting to a secondary network to be used if the primary network becomes unavailable.

The HQ node 149 may be a node from where the operation of the squad 105 is controlled. For example, the HQ node 149 may provide instructions to each member of the squad 105 or to the squad as a whole to execute a mission in the field. In some embodiments, the HQ node 149 is a stationary or semi-stationary node. For example, the HQ node may be installed in a building that operates as a command center for the operations of the squad. Alternatively, the HQ node may operate from a vehicle, such as a High Mobility Multipurpose Wheeled Vehicle (HMMWV or Humvee). In some embodiments, the HQ node 149 has a higher computational capability than each of the nodes 110.

The nodes 110 and the HQ node 149 are configured to communicate via the cloud network 170, which may comprise any combination of local area and/or wide area networks, using both wired and/or wireless communication systems. For example, the network 170 may communicatively couple two or more squads 105, and their respective nodes 110, within a local area network and further communicatively couple with HQ 149 and/or third-party system 190, within a wide area network. In one embodiment, the cloud network 170 uses various communications technologies and/or protocols. For example, the cloud network 170 includes communication links using technologies such as Ethernet, 802.11, worldwide interoperability for microwave access (WiMAX), generational cellular data networks (e.g., 3G, 4G, 5G, 6G, or other x-generation mobile network technology (x being an integer)), code division multiple access (CDMA), digital subscriber line (DSL), etc. Examples of networking protocols used for communicating via the cloud network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the cloud network 170 may be represented using any suitable format, such as hypertext markup language (HTML) or extensible markup language (XML). In some embodiments, all or some of the communication links of the cloud network 170 may be encrypted using any suitable technique or techniques. Further, the cloud network 170 may be a private network and may be configured to include additional security protocols, including authentication mechanisms and/or encryption mechanisms.

One or more third party systems 190 may be coupled to the cloud network 170 for communicating with the nodes 110 or the HQ node 149. In one embodiment, a third-party system 190 is an application provider communicating information describing applications for execution by the nodes 110 or the HQ node 149, or communicating data to the nodes 110 or the HQ node 149 for use by an application executing on the nodes 110 or the HQ node 149. In other embodiments, a third-party system 190 provides content or other information for presentation via a node 110.

Furthermore, each node 110 may comprise a synchronization module 251 and a multicast beaconing module 252, which may store computer-readable instructions for performing actions when participating in the synchronization protocol. One or more processors of a node 110 may execute instructions of the synchronization module 251 or multicast beaconing module 251 depending on if the node 110 is acting as synch node 110A or beacon node 110B at a particular moment in time assigned in the discovery interval data structure 150.

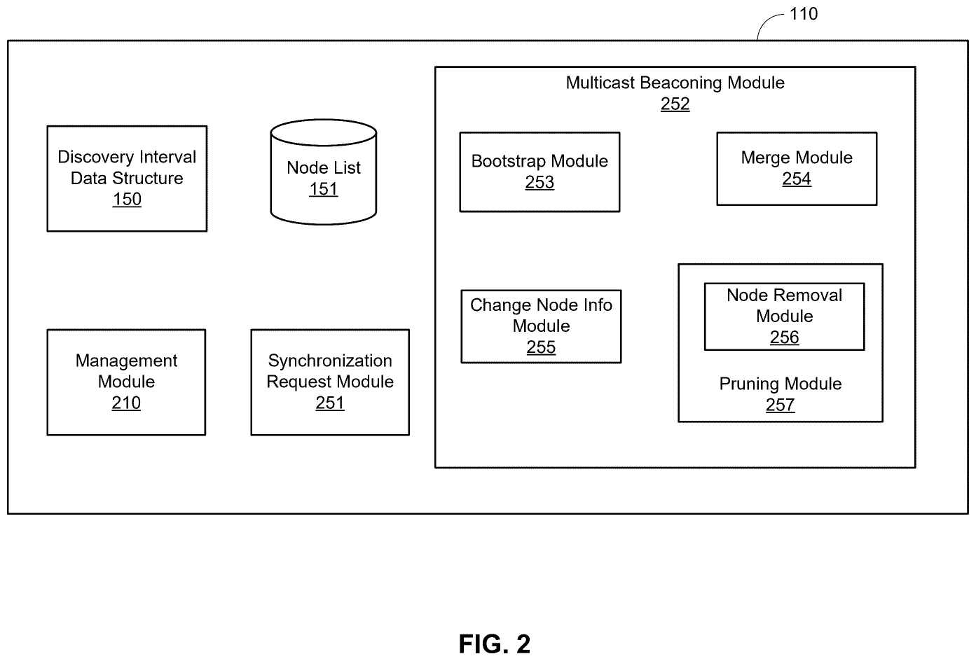

Turning now to FIG. 2, illustrated is a block diagram of a node 110, according to one or more example embodiments. As illustrated, the node includes a synchronization request module 251, a multicast beaconing module 252, the discovery interval data structure 150, the node list 151, a bootstrap module 253, a merge module 254, a change node info module 255, a pruning module 257, a node removal module 256, and a management module 210. In other embodiments, the node 110 may include additional, fewer, or different components for various applications. It is noted that the reference to modules is for ease of discussion. Modules may be hardware-based modules (e.g., a processor (e.g., one or more processors, controllers, and/or state machines configured specifically to executed functions as described herein) based system configured to execute the functionality described), software-based modules (e.g., software components structured as computer program code comprised of instructions storable on a non-transitory computer readable storage medium) and executable by a processor, or a combination thereof (e.g., firmware configured as coded program code within a hardware component having a processor).

The management module 210 is configured to receive event messages, process the event messages, and determine the number and method of communication channels to be used for rendering the events to the HMI. In some embodiments, the management module 210, includes hard-coded or program-determined notification paths. Moreover, the management module 210 may allow for custom notification paths (e.g., through an if-this-then-that user interface and programming paradigm). The management module 210, may track events that have been acknowledged and the events that have been already seen, and outputs the events to the appropriate channels of the HMI. In some embodiments, the management module 210 has the options of forwarding un-acknowledged events to other members of the squad in an escalation scheme.

In some embodiments, the management module 210 maintains a notification database. The notification database may store a set of notifications that have been provided to the user of the node 110. Moreover, the notification database may include an indication whether each of the notifications have been acknowledged by the user of the node 110. In some embodiments, the notifications are stored as a time-series (e.g., organized by timestamp). Moreover, for each notification, the notification database may store information about the source of the notification. For example, if a notification is provided to a user of a node 110 in response to an event detected by another node, the notification database stores information about the node that triggered the notification, the equipment that captured the data that triggered the notification, the location of the node that triggered the notification when the notification was triggered, etc.

The management module 210 allows for the shared utilization of a central processing unit (CPU), graphical processing unit (GPU), memory, battery, and other limited computational systems across the nodes 110 connected through the p2p network 160 (or optionally through the cloud network 170). For example, the management module 210 enables computer processing tasks to be spread across the multiple nodes 110. The management module 210 may receive as inputs task request for processing image streams, audio streams, and other signal data (e.g., radio, infra-red, data-feeds, etc.).

By way of example, machine learning and computer perception models or algorithms can be applied to image streams or audio streams. These models or algorithms may be resource intensive and time consuming. To alleviate the constraint of these resource-intensive and time-consuming tasks on nodes with limited capabilities, tasks are shared across multiple nodes 110. The management module 210 coordinates the execution of these tasks across multiple nodes connected to each other via the p2p network 160. The management module 210 may also handle tracking utilization of on-board resources and querying and recording the resource utilization across the nodes 110 of the squad 105. In some embodiments, the output of the management module 210 is a stream of events representing the detection and perception results from the machine learning and computer perception models or algorithms on the input data streams, and events that represent requests for data off-load to other nodes within the squad.

The management module 210 is configured to manage events and event messages between the nodes 110 of a squad 105. For example, the management module 210 is configured to receive event messages from other nodes 110 of the squad 105 and perform one or more actions based on the contents of the received event message. Moreover, the management module 210 may be configured to forward event messages to other nodes 110 (e.g. connected to the p2p network 160).

In some embodiments, events associated with event messages correspond to interactions by a user of a node 110 through the HMI 125 of the node 110, outputs of the management module 210, changes detected by the management module 210, outputs from the computing system 130, and the like.

In some embodiments, the management module 210 is configured to track a history of an event. For example, the management module 210 may keep track of whether actions for addressing the event have been performed by nodes of a squad. Moreover, the management module 210 is configured to de-duplicate and/or merge event messages corresponding to the same event.

The management module 210 is configured to manage the connection between a node 110 and other nodes that are connected to the p2p network 160. Moreover, the management module 210 may be configured to manage the connection between nodes 110 and other nodes (such as the HQ node 149 or a third-party system 190) connected to the cloud network 170.

In some embodiments, the management module 210 is configured to monitor the connections between a node 110 and other entities (such as other nodes, the HQ node, or third-party systems) connected to the network. The management module 210 may keep track of the signal strength and network paths between the node 110 and other entities connected to the node through the p2p network 160.

Synchronization request module 251 initiates a synchronization process between two or more nodes 110 in a squad 105. Namely, the synchronization request module 251 transmits a unicast synchronization request to the transmitter of a multicast beacon. The unicast synchronization request is a data message that comprises the node list 151, in particular, the stored node list of the transmitter, and that may trigger an event that will cause the multicast beacon transmitter to transition into a new state. In one embodiment, the unicast synchronization request may be a bidirectional unicast protocol (e.g., remote procedure call, such as provided through an RPC service). That is, the unicast synchronization request message from a transmitter may call a synchronization service at the receiver. In one embodiment, the unicast synchronization request may further comprise a removed list. The removed list may contain a list of nodes 110 to remove from the squad 105.

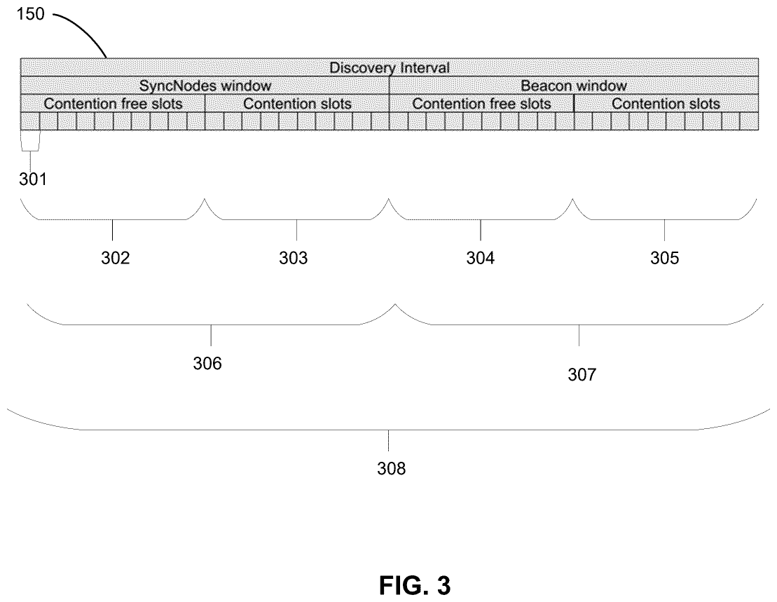

Computer-readable instructions of the synchronization request module 251 are executed during a discovery interval by a node 110A (or processor thereof) during an allotted time slot in a synchronization window that the synch node 110A is assigned to (as described in greater detail with respect to FIG. 3 further below). As used herein, a “synchronization window” may refer to a time window in which a unicast synchronization request may be expected by the nodes 110 in a squad 105 to be transmitted during the discovery interval.

In embodiments, the synchronization request module 251 is configured to listen for a multicast beacon during a duration of the discovery interval, and in response to receiving the multicast beacon during the duration of the discovery interval, transmit a unicast synchronization request to the transmitter of the multicast beacon. For example, the multicast beacon may be a first multicast beacon that is listened for during a beacon window, prior to receiving a second (follow-up) multicast beacon containing node information differences. As used herein, a “beacon window” may refer to a time window in which a multicast beacon may be expected by the nodes 110 in a squad 105 to be transmitted during the discovery interval.

Transmission of multicast beacons can be computationally expensive, or drain other resources such as power, memory, and network bandwidth; therefore, a unicast synchronization request may instead be used to synchronize data between two nodes in squad 105, such as resolving any node information differences between a received node list and a stored node list. As used herein, “node information differences” may refer to differences in data associated with a node in the node list 151, such as new or missing information about the nodes 110 in a squad 105 and/or their characteristics (e.g., the current state of a node 110, the services it is running, the sensors that are operational on the node 110, etc.).

Upon synchronizing and resolving node information differences between the two nodes, the changes to the node list can then be propagated to other nodes in the squad 105. The sequence of actions for resolving the node information differences may be carried out according to time slots configured in a discovery interval data structure 150 stored at each node 110.

Multicast beaconing module 252 transmits multicast beacons, such as for multicasting data to the squad 105. The multicasting signal may be a broadcast signal. In embodiments, the multicast beacon may comprise the beacon transmitter's (e.g., beacon node 110B) node information, a network identifier, a node count (e.g., number of nodes in the squad 105 or counted in the node list 151), a hash of the node information in the node list 151 (e.g., hash of all node information as known to be current and update by the beacon node 110B), a set of updates and/or removals from the node list 151 (e.g., node list differences), other information for the squad 105, or some combination thereof. In one embodiment, the multicast beacon is sized to fit inside a single user datagram protocol (UDP) maximum transmission unit (MTU) to avoid fragmentation. In embodiments, the multicast beacon may be a serialized data message, such as Protocol Buffers (Protobuf) beacon.

Computer-readable instructions of the multicast beaconing module 252 are executed during a discovery interval by a node 110A (or processor thereof) during an allotted time slot in the beacon window that the beacon node 110B is assigned to (as described in greater detail with respect to FIG. 3 further below). In embodiments, multicast beaconing module 251 may transmit out the multicast beacon when the allotted time slot has lapsed or its associated timer has expired. Multicast beaconing module 252 also transmits the multicast beacon on-demand upon receiving a unicast synchronization request, or if the beacon node 110B fails to reach a node 110 in the squad 105.

In embodiments, multicast beaconing module 252 compares the node list 151 in the unicast synchronization request to its stored node list (as a beacon node 110B) and determines node information differences based on the comparison. In response to determining node information differences, multicast beaconing module 252 requests node information from the nodes associated with the node information differences. For example, the beacon node 110B may generate and transmit a message call to directly exchange node information with a single node 110 in the squad 105. The beacon node 110B may generate and transmit multiple message calls to exchange node information individually and directly with each node that is associated with a determined node information difference. The request for node information, also referred to herein as a “node information call,” may be a bidirectional unicast protocol (e.g., remote procedure call, such as provided through an RPC service). The node information call may act as a direct query, where a node 110 that receives the node information call may respond with its identifier (e.g., name, network address, order in the node list, and/or priority in the discovery interval) and characteristics (e.g., list of running services or other node information). As an example, the beacon node 110B may transmit a node information call to a node 110 that is listed as losing or gaining service in the node list 151 of the synch node 110A which has not been accounted for in the stored node list of the beacon node 110B. As such, the beacon node 110B can directly verify with the node 110 in question which node list 151 is correct and up to date. As another example, the beacon node 110B may transmit a node information call to a node 110 that is included in its stored node list 151 but that has been removed from the node list 151 (e.g., added to a remove list) of the synch node 110A. In both examples, the beacon node 110B may listen for a response to the node information call to receive the node information from the associated nodes.

In one embodiment, if the node information call fails (e.g., because the node in question is not reachable), then the beacon node 110B may adopt the node information from the larger list between its stored node list 151 and the node list 151 of the synch node 110A. That is, if its own node database/node list 151 is larger than the node list 151 provided in the unicast synchronization request, then the beacon node 110B accepts its own information as being more likely to be true, and vice-versa.

In one embodiment, if a removed list of the synch node 110A contains nodes 110 that the beacon node 110B had in its current node list 151, then the beacon node 110B may set the nodes in the removed list aside (also referred to herein as “pending removal nodes”) and transmit a node information call to resolve the conflict. If the node information call succeeds, then the pending removal nodes may be included as an update in a “node information difference” list. The node information difference list may be a list, relational table, or other data structure that delineates node information differences that are to be propagated by the beacon node 110B to the nodes 110 of the squad 105 in a follow-up multicast beacon. If the node information call fails, then the pending removal nodes may be included as/associated with a removal action in the node information difference list.

In embodiments, the beacon node 110B updates its stored node list using the node information received in the node information calls made to all of the nodes associated with the node information differences between its stored node list 151 and the synch node 110A's node list 151. After updating its stored node list 151, the beacon node may generate a second (new) hash of the node information in its stored node list 151. In one embodiment, when a multicast beacon is received by another node 110 in the squad 105, the receiver first updates or removes any nodes 110 included in the node difference list. The removed nodes may then be added to the removed list, regardless of whether they were previously known. In one embodiment, if needed, the receiver also incorporates the transmitter's (e.g., the beacon node 110B) node information from the multicast beacon, even if no node information differences are specified. Then, the receiver compares the node count and hash in the multicast beacon to its own (revised/updated) node list 151. If the receiver detects a difference between its node list 151 and the transmitter's node list 151, either by node count or hash, it selects a discovery interval from the synchronization window as backoff time (e.g., shorter than the shortest beacon window time slot, but longer than the slot time delay, in case of fragmentation). During this backoff time, reception of a new multicast beacon continues the process of incorporating node information differences. If, after the backoff time, a node 110 in the squad 105 still has not received an updated multicast beacon with the same node count and hash as its own, the node 110 may transmit a unicast synchronization request to the most recent multicast beacon transmitter using its current stored node list 151 and the removed list.

In embodiments, the multicast beaconing module 252 is further configured to generate a second (“follow-up”) multicast beacon comprising a second (updated) hash of its stored node list 151 and transmit/multicast the second multicast beacon to the nodes 110 in the squad 105. Once any differences are resolved in this manner, the beacon node 110B may immediately transmit the second multicast beacon with the node information difference list accumulated through making the node information calls to the corresponding nodes associated with each information difference. In one embodiment, when there is large set of node information differences to be resolved, the beacon node 110B may preemptively transmit the second multicast beacon while the node information differences are still resolving. At that point in time, the second multicast beacon may be sent with only the node information differences that have already been resolved, and the other nodes 110 in the squad may reset their synchronization window backoff timers, thereby giving the node information calls time to complete and resolve the entire set of node information differences in a subsequent cycle through the discovery interval.

In one embodiment, if a beacon node 110B has a stored node list 151 that contains no other nodes 110 other than itself, then it may have no squad 105 member (e.g., mesh neighbors) who may benefit from node information differences sent in a second multicast beacon. In this embodiment, when the beacon node 110B receives a unicast synchronization request from a synch node 110A, the node may immediately integrate the synch node 110A's entire node list and transmit the second multicast beacon without any node information differences.

In one embodiment, as a further optimization, when a beacon node 110B's node list is small and the synch node 110A's node list is large, the beacon node 110B may transmit a node information call to every previously known node 110 in the squad 105 directly, and the nodes 110 may skip multicast beacon transmission unless there are further discrepancies.

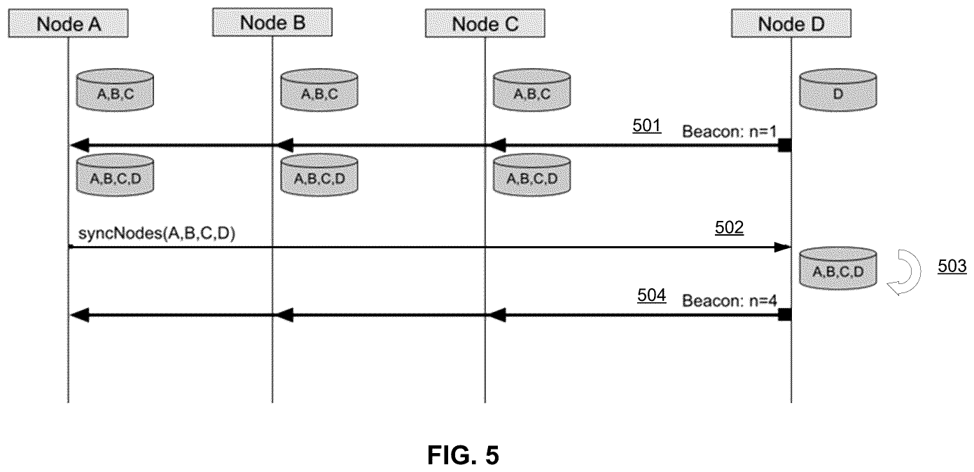

Multicast beaconing module 252 may comprise a bootstrap module 253 configured to transmit a first multicast beacon comprising a first node count and receive the unicast synchronization request comprising a second node count. The bootstrap module 253 is further configured to generate a second multicast beacon comprising the second node count and transmit the second multicast beacon. Further details regarding bootstrapping a node 110 into a squad 105 are provided with respect to the description of FIG. 5 further below.

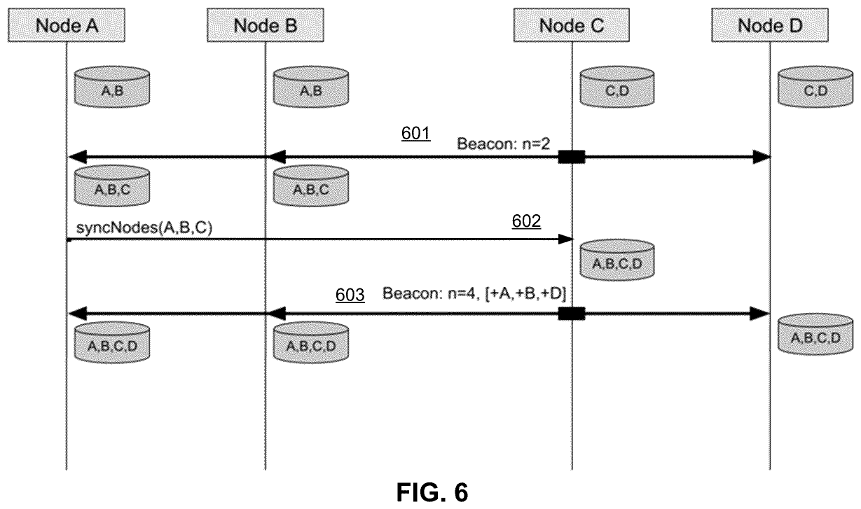

Multicast beaconing module 252 may comprise a merge module 254. The merge module is configured to transmit a first multicast beacon during a beacon window, receive a unicast synchronization request during a synchronization window, and transmit a second multicast beacon comprising node information differences in a node list 151, including nodes 110 newly added or merged into a squad 105. Further details regarding merging nodes 110 of a first squad 105A and second squad 105B are provided with respect to the description of FIG. 6 further below.

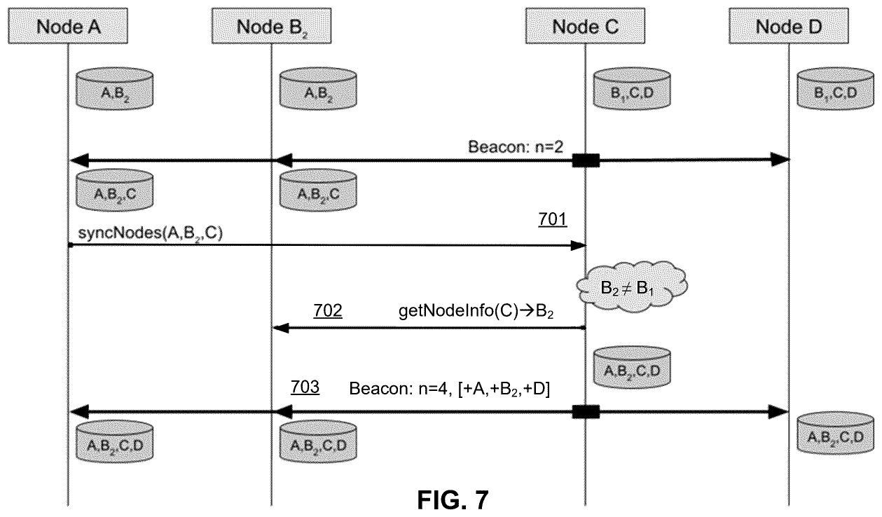

Multicast beaconing module 253 may comprise a change node info module 255. The change node info module 255 is configured to receive a unicast synchronization request from a first node in a squad 105. The first node is different from nodes associated with node information differences found in the node list 151 of the beacon node 110B. The change node info module 255 receives a response to a request for node information. The received response comprises the node information differences. The change node info module 255 further transmits a second multicast beacon comprising the node information differences. Further details regarding changing an existing node's node information are provided with respect to the description of FIG. 7 further below.

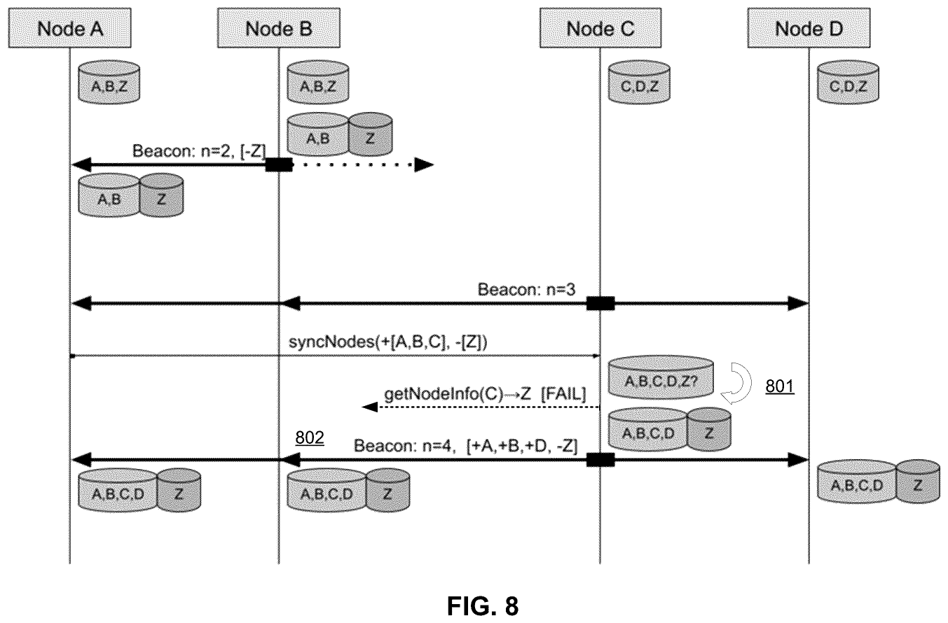

Multicast beaconing module 252 may further comprise a pruning module 257 configured to prune the node list 151. The pruning module 257 may further comprise a node removal module 256. The node remove module 256 is configured to determine a failure in a request for node information differences from the removed node and transmit a second multicast beacon comprising the node removal. Further details regarding removing a node 110 from a current node list 151 are provided with respect to the description of FIG. 8 further below.

FIG. 3 is an illustration of a discovery interval data structure, according to one or more embodiments. The discovery interval data structure 150 divides the discovery interval 308 into time slots 301. As used herein, a “time slot” may refer to an interval of time in which a particular node 110 in a squad 105 is assigned to perform an action, such as transmitting or receiving a message. As previously mentioned, the duration of each time slot and the expiration of its corresponding timer may be a fixed constant configured for the squad and may be configured based on propagation delays for the P2P network 160. The time slots are organized into a first pool 302 of time slots and a second pool 303 of time slots. The duration of the discovery interval sets the timer for each discovery action (e.g., transmitting and receiving of messages, such as calling the synchronization service or transmitting beacons containing node information differences and other updates to a node list). The first time slots 301 are time slots reserved for nodes to transmit the unicast synchronization request during a synchronization window. The second pool 303 of time slots are time slots reserved for nodes 110 to transmit the first multicast beacon during a beacon window.

The first “N” nodes in a squad 105 in sorted order each get one of the contention free slots and the rest of the devices select one of the contention slots. As used herein, “a contention free slot” may refer to a time slot that is assigned to a node according to a determined sequence. For example, each node assigned to a contention free slot may have a priority number indicating its order in the node list 151 and its priority in the discovery interval (e.g., which contention free slot it is assigned in the beacon window and synchronization window). As such, the ordering of the contention slots help to avoid collisions between transmitted messages from the nodes 110 in the squad 105. In one embodiment, the order in the node list 151 and priority in the discovery interval may be sorted according to network address. As used herein, a “contention slot” may refer to a time slot this is assigned to a node according to an undetermined sequence. For example, in one embodiment, only a fixed number of high priority nodes 110 may be assigned a contention free slot, while the remainder of nodes 110 of lower priority may be relegated to the contention slots. The contention slots may not be ordered, but may allotted randomly (e.g., random backoff), on a first come, first serve basis, or according to some other stochastic process in scenarios where all of the high priority nodes 110 in the contention free slots lose connectivity with the squad 105. As such, the contention slots ensure that a multicast beacon can be sent quickly in scenarios of major network failure or dramatic loss in connectivity amongst the squad 105.

Every node 110 may reset the discovery interval (e.g., resetting the timers configured for each node 110) upon receiving a multicast beacon (e.g., a single-multicast beacon transits the network per discovery interval). In embodiments, the node 110 that is at the top of the node list 151 (e.g., highest priority) for the squad 105 may be assigned as the beacon node 110B and may be responsible for transmitting the multicast beacon to the rest of the squad 105. A second (follow-up) multicast beacon may be transmitted to verify that the updates to the node list during the synchronization window have been accepted and the node information differences have been resolved. When transmitted during the beacon window, a multicast beacon may comprise an empty node information difference list.

If the highest priority node does not transmit the multicast beacon on schedule (e.g., discovery interval timer has expired), then the next highest priority node in the node list will be assigned as the beacon node 110B and transmit the multicast beacon to the squad 105, and so on. As such, as squads 105 merge and split, and as beacon nodes 110B lose connectivity with the squad 105, a new beacon node 110B is assigned.

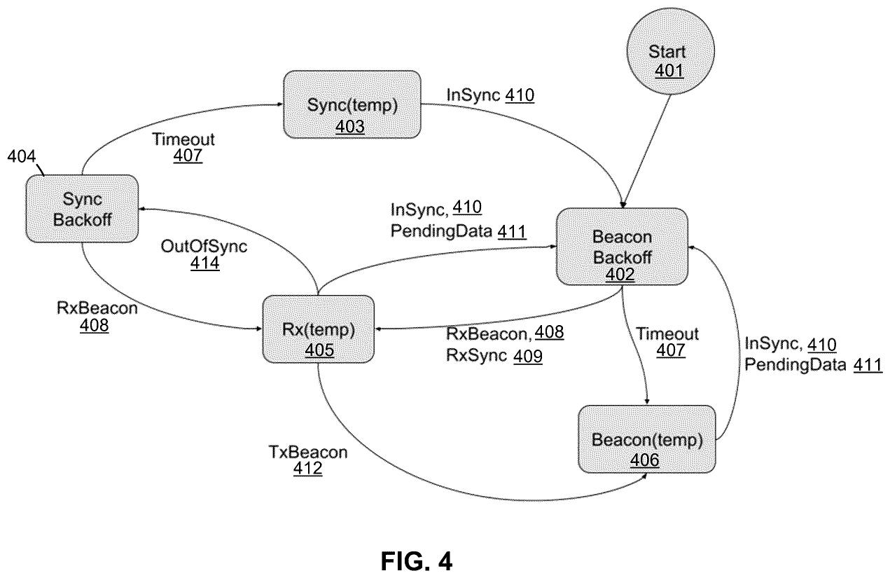

FIG. 4 is an illustration of a state diagram of a node 110 executing a discovery and synchronization protocol, according to one or more embodiments.

Start 401 is a state in which the synchronization protocol starts.

Beacon Backoff 402 is a state in which a node is waiting to either receive or transmit a beacon.

Sync (temp) 403 is a state in which will contact the beacon transmitter in order to synchronize data.

Sync Backoff 404 is a state in which a receiving node has determined that it is out of sync with the beacon transmitter. The receiving node is waiting for an opportunity to contact the beacon transmitter.

Rx (temp) 405 is a state in which a node will process a received beacon.

Beacon (temp) 406 is a state in which a node will transmit a beacon.

A node 110 may enter into one or more of the above-mentioned states depending on an event that causes the node 110 to transition from one state into the next. The events may include timeout 407, RxBeacon 408, RxSync 409, InSync 410, PendingData 411, TxBeacon 412, and OutofSync414.

Timeout 407 may be an event where a specified amount of time has elapsed.

RxBeacon 408 may be an event where a beacon has been received by a node over the network.

RxSync 409 may be an event where a synchronization message has been received by a node over the network.

InSync 410 may be an event where a node has determined that its node list contains the same data as the rest of the network.

PendingData 411 may be an event where there are node list updates that need to be communicated to all nodes in the network.

TxBeacon 412 may be an event where a node needs to transmit a multicast beacon.

OutofSync 414 may be an event where a node has determined that data in its node list does not match the rest of the network.

Upon start 401, a node 110 may transition into beacon backoff 402. From beacon backoff 402, the node 110 may timeout 407 and transition into beacon (temp) 406. Or, in the event of RxBeacon 408 or RxSync 409, the node may transition into Rx (temp) 405.

From Beacon (temp) 406, the in the event of InSync 410 or PendingData 411 the node 110 transitions into Beacon Backoff 402.

From Rx (temp) 405, in the event of TxBeacon 412, the node 110 transitions into Beacon (temp) 406. In the event of InSync 410 or PendingData 411 the node 110 transitions into Beacon Backoff 402. In the event of OutOfSync 413, the node 110 transitions into Sync Backoff 404.

From Sync Backoff 404, in the event of RxBeacon 408, the node 110 transitions into Rx (temp) 405 or may timeout 407 transition into Sync (temp) 403.

From Sync (temp) 403, in the event of InSync 410, the node 110 transitions into Beacon Backoff 402.

FIG. 5 illustrates a diagram of an example for bootstrapping a node into a squad, according to one or more embodiments. As shown in this example, Node D performs a method of transmitting 501 a first multicast beacon comprising a first node count, receiving 502 a unicast synchronization request comprising a second node count; generating 503 a second multicast beacon comprising the second node count, and transmitting 504 a second multicast beacon.

In this example, Nodes A, B, and C are an existing quiescent mesh with full knowledge of each other and connectiveness as a squad, e.g., squad 105. Node D boots and has no knowledge of the squad 105 beyond itself. Node D starts with a short (or zero) interval timer for transmitting the first multicast beacon, as its node list 151 is empty other than itself. As the multicast beacon propagates, Nodes A, B, and C all add node D to their respective node lists 151. The node count and hash in D's multicast beacon do not match their own, so they each start backoff timers for transmitting a unicast synchronization request at an allotted time slot during the synchronization window. Node A's backoff timer is shortest, as its address was first in the sort order of [A, B, C], which may be stored in a database in Node A. When Node A's timer expires, it transmits a unicast synchronization request to call the synchronization service of Node D. The unicast synchronization request sent from Node A to Node D comprises Node A's complete node list 151, which will include node D and its node information.

Node D compares this list of updates in the node list 151 to its own stored node list 151. Having only itself in its stored node list 151, no other Nodes 110 in the squad 105 would benefit from propagating a full set of node information differences via a second multicast beacon. Therefore, Node D follows a bootstrapping mentioned above, and transmits a second multicast beacon with the new node count (as received from node A) and a hash of the complete node list received from Node A. This second multicast beacon stops the backoff timers of Nodes B and Node C. That is, the discovery interval resets before reaching the allotted time slots for Node B and Node C in the synchronization window and they do not transmit out a unicast synchronization request to Node D during the discovery interval. At this state, all of Nodes A, B, C, and D now have up-to-date node information matching the second multicast beacon (# of nodes in the squad 105, n=4), and all of the Nodes A, B, C, and D in the squad 105 reset their beacon window timers upon reception in their respective databases. Node A remains the first (highest priority) node in sorted order, so if no other nodes appear, Node A will be the next node in the squad 105 to transmit a multicast beacon.

FIG. 6 illustrates a diagram of an example for merging squads, according to one or more embodiments. As shown in this example, Node C implements a method of transmitting 601 a first multicast beacon during a beacon window, receiving 602 a unicast synchronization request during a synchronization window, and transmitting 603 a second multicast beacon comprising the one or more node information differences.

In this example, Nodes A and B are an existing quiescent mesh with full knowledge (as per what is stored in their respective databases) of each other and connectivity as a squad 105A. Nodes C and D are likewise existing with knowledge of each other and connectivity as a second squad 105B. At some point prior, the underlying mesh joins these two mesh networks/squads 105 together. Convergence starts when one of the nodes' timer in the allotted time slot of the beacon window expires. In this case, Node C transmits a first multicast beacon, as it was first in the sort order of [C,D], and had no knowledge of [A,B], or their last beacon time. This first multicast beacon advertises C's known node count of 2.

Upon reception, Nodes A and B add Node C to their node lists and start backoff timers for their allotted time slots in synchronization window because the first multicast beacon's node count and hash do not match the hash of their own node information in their stored node lists. Node A's timer expires first because it is first in the sort order of [A,B], so it transmits a unicast synchronization request to call the synchronization service of Node C with its complete node list of known nodes (including C itself, but not D). Node C compares this node list to its own stored node list. As Node C was missing nodes A and B from its stored node list, it adds those nodes to a node information difference list to be propagated in a second multicast beacon. As Node D was missing from Node A's node list, Node D is also added to the node information difference list. Node C then immediately transmits the second multicast beacon with the three node information differences in the node information difference list. This second multicast beacon has an updated node count of 4 nodes and a corresponding updated hash.

Upon reception of the beacon, Nodes A, B, and D incorporate the node information difference into their own node lists. As this node information difference list brings their node lists into alignment with Node C's, they compute the same node count and hash as in the second multicast beacon. This cancels any remaining timers for the remaining time slots in the synchronization windows and resets the timers for the beacon window. In the resulting squad, Node A appears first in sorted order, so it will be the first to transmit a first (new) multicast beacon if no other nodes join the squad 105.

FIG. 7 illustrates a diagram of an example for changing an existing node's node information, according to one or more embodiments. As shown, Node C performs a method of receiving 701 a unicast synchronization request from a first node, Node A, in the plurality of Nodes A, B, C, and D in the squad 105, the first node, Node A being different from one or more nodes, Node B, associated with one or more node information differences. The method further comprises receiving 702 a response to the request for the node information from the one or more nodes, Node B, associated with the one or more node information differences, the response comprising the one or more node information differences. The method further comprises transmitting 703 a second multicast beacon comprising the one or more node information differences.

When a node, Node B, changes its identifier (e.g., name), services, or other node information, it rejoins the squad 105 according to the bootstrap method of FIG. 5. Since the second multicast beacon from the previous discovery interval includes Node B's most recent node information, the other nodes 110 in the squad 105 may immediately update their node lists and follow said bootstrap method. However, if node B rejoins a fragment of the network, or some other network or squad, then those networks merge with a network where node B was previously known, but with old node information.

In this example, Nodes C and D may be aware of a prior instance of Node B's old node information (denoted B1). However, Node B had changed its service set (updating its node information to B2) and restarted in a network/squad with Node A. These two meshes then join, as in the merger method of FIG. 6, except they have conflicting information for Node B. In this case, when Node A transmits a unicast synchronization request to call the synchronization service of Node C, Node C has no way of knowing whether its stored node list or the node list of node A is correct with respect to Node B's services. Instead of guessing, Node C transmits a node information call to Node B. In this way, Node B may be a single point of truth for node information about Node B, and only the beacon transmitter (beacon node 110B) needs to call Node B to arbitrate any node information differences. Having determined that the correct information for Node B is, in fact, B2, C then transmits a second (follow-up) multicast beacon with the resulting node information differences, including B2. This resolves the difference across all nodes that hear the second multicast beacon.

FIG. 8 illustrates a diagram of an example for removing a node from a current node list, according to one or more embodiments. In the embodiment, the node information differences comprise a node removal. As shown, Node C performs a method of determining 801 a failure in the request for the node information differences at a node, Node Z, relating to the node removal, and transmitting 802 a second multicast beacon comprising the node removal.

When a node, Node A, elects to remove Node Z from its current node list, it moves Node Z to its removed list. Other nodes in the connected mesh are then notified in a multicast beacon and likewise move the node from their current node lists to their removed lists. If other nodes are aware of Node Z, but do not hear the multicast beacon, either because they simply missed the multicast beacon, or because they were part of another mesh cluster/squad 105 that later merged, a conflict may exist. This conflict will trigger the beacon node 110B (here Node C) to transmit a node information call to Node Z. If the node information call is successful, Node C will include Node Z in a second multicast beacon as an updated addition to the squad 105. If the node information call fails, Node C will include Node Z a removal in the second multicast beacon as a removal from the squad 105. As shown in FIG. 8, Node Z is first removed by a multicast beacon from Node B, but only Node A hears the multicast beacon. Later, Node C merges the squads 105 and configures new timers for the beacon window of the discovery interval, and Node A responds to the difference in hash with a unicast synchronization request. This triggers Node C to resolve the conflict about Node Z by trying and failing to make a node information call to Node Z. Then, Node C issues a second (follow-up) multicast beacon that adds any missing nodes and removes Node Z.

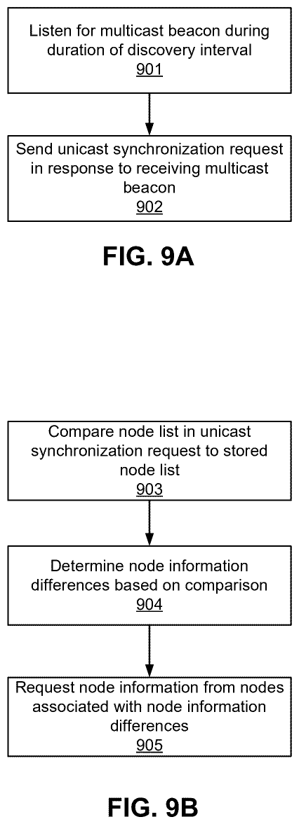

FIG. 9A illustrates a method of synchronization of nodes performed using instructions of synchronization request module 251, according to one or more embodiments. The method may be implemented as instructions stored on a computer-readable medium of a node 110, namely, a synch node 110A. When one or more processors of the node 110 executes the instructions, the instructions cause the processor to perform the method.

The processor listens 901 for a first multicast beacon during a duration of a discovery interval. For example, synch node 110A may be allotted a time slot in the synchronization window and will wait to hear the first multicast beacon during its allotted time slot. As one example, the synch node 110A may be the third time slot in the synchronization window and will have until the expiration of the third timer in the synchronization window to expect the first multicast beacon from a beacon node 110B. If it does not hear the first multicast beacon by the expiration of the timer for the third time slot, the discovery interval will move onto the next node, which will listen for the first multicast beacon. If the synch node 110A does hear the first multicast beacon during its time slot in the discovery interval, it will transmit a unicast synchronization request.

In response to receiving the first multicast beacon during the duration of the discovery interval, the processor transmits 902 a unicast synchronization request to the transmitter of the first multicast beacon.

FIG. 9B illustrates a method of synchronization of nodes performed using instructions of multicast beaconing module 252, according to one or more embodiments. The method may be implemented as instructions stored on a computer-readable medium of a node 110, namely, a beacon node 110B. When one or more processors of the node 110 executes the instructions, the instructions cause the processor to perform the method.

The processor compares 903 the node list in a unicast synchronization request to a stored node list of a transmitter of the first multicast beacon. For example, a beacon node 110B responsible for transmitting the first multicast beacon receives a node list from a synch node 110A that is next in line in the synchronization window as a response to the first multicast beacon.

The processor determines 904 one or more node information differences based on the comparison. For example, the synch node 110A that transmits the unicast synchronization request may have a node list and hash that differs from the beacon node 110B.

In response to determining the one or more node information differences, the processor requests 905 node information from one or more nodes associated with the one or more node information differences. For example, the node list of the synch node 110A may include a removal of a node from the squad 105, and the beacon node 110B may transmit a node information call to the node associated with the removal, i.e., the node that may or may not have been removed from the squad 105.

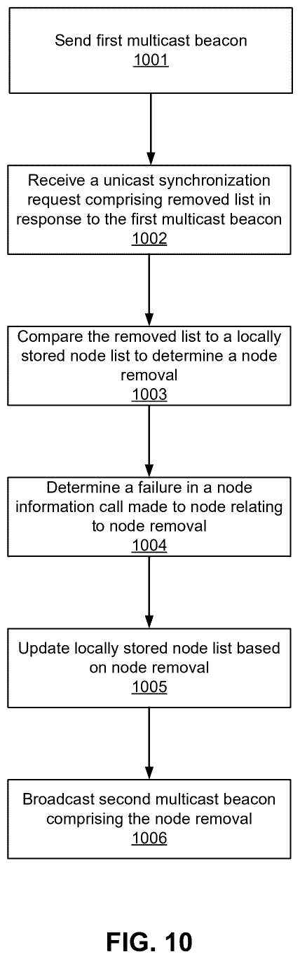

FIG. 10 illustrates a method of pruning a node list for a squad, according to one or more embodiments. In embodiments, the node list may be implemented as a distributed database. The method may be implemented as instructions stored on a computer-readable medium of a node 110. When one or more processors of the node 110 executes the instructions, the instructions cause the processor to perform the method. In embodiments, the method may be implemented as computer-readable instructions of pruning module 257. As previously mentioned, each node also maintains a list of recently removed nodes, i.e., a removed list. In embodiments, the removed list may not be included in node counts or hash computations, but rather, may serve as a “penalty box” for recently removed nodes.

The processor 1001 transmits a first multicast beacon.

The processor receives 1002 a unicast synchronization request in response to the first multicast beacon. The unicast synchronization request comprising a removed list for the distributed database.

The processor compares 1003 the removed list to a locally stored node list to determine a node removal.

The processor determines 1004 a failure in a node information call made to a node relating to the node removal.

Subsequent to (e.g., responsive to) determining the failure, the processor updates 1005 the locally stored node list based on the node removal.

The processor transmits 1006 a second multicast beacon comprising the node removal. Nodes receiving the second multicast beacon update a locally stored removed list using the node removal.

Embodiments provide several technical advantages. In embodiments, a beacon transmitter acts as a self-nominated time base and arbiter for the known mesh, and changes are pushed back to the beacon transmitter for difference resolution and re-beaconing. In a mesh, multicasts expand outward from the transmitter, so distant nodes will receive the multicast at later times than nearer nodes. Unicasting to the original transmitter allows that transmitter to mediate the timing and prevent multiple responses from near and far nodes (e.g., avoids collision). Furthermore, embodiments reduce the number of multicast beacons that need to be sent in order to synchronize the distributed databases of the mesh (e.g., the node lists for the squad).

### Examples of Data Processing Pipelines

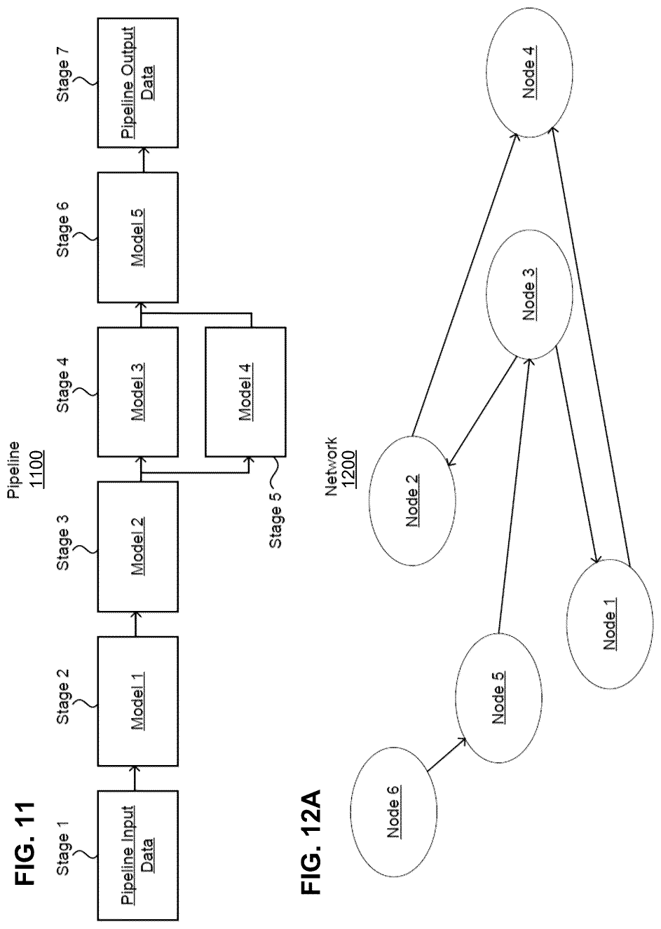

FIG. 11 is a block diagram of an example pipeline 1100, according to one or more embodiments. The pipeline includes data flowing along seven stages (labeled 1-7). The arrows indicate the flow of data through the pipeline. Stages 2-6 includes detection models (labeled 1-5) that process received data. Example types of pipeline input data include one or more images, one or more video frames, audio data, or some combination thereof. Data may also be referred to as a piece of media. Example detection models include a human detection model, a face detection model, a model that determines relative distance, a model that determines if a surface or object is metallic, a model that filters out background noise, a model that converts LIDAR data into a visual image, a model that applies one or more detection filters based on one or more attributes (e.g., color or size of an object, an OCR (optical character recognition) model that converts an image into text, a model that looks up a license plate in a database and attaches or filters on the resulting metadata, or any other type of model configured to detect, measure, or otherwise extract relevant information from the pipeline input data.

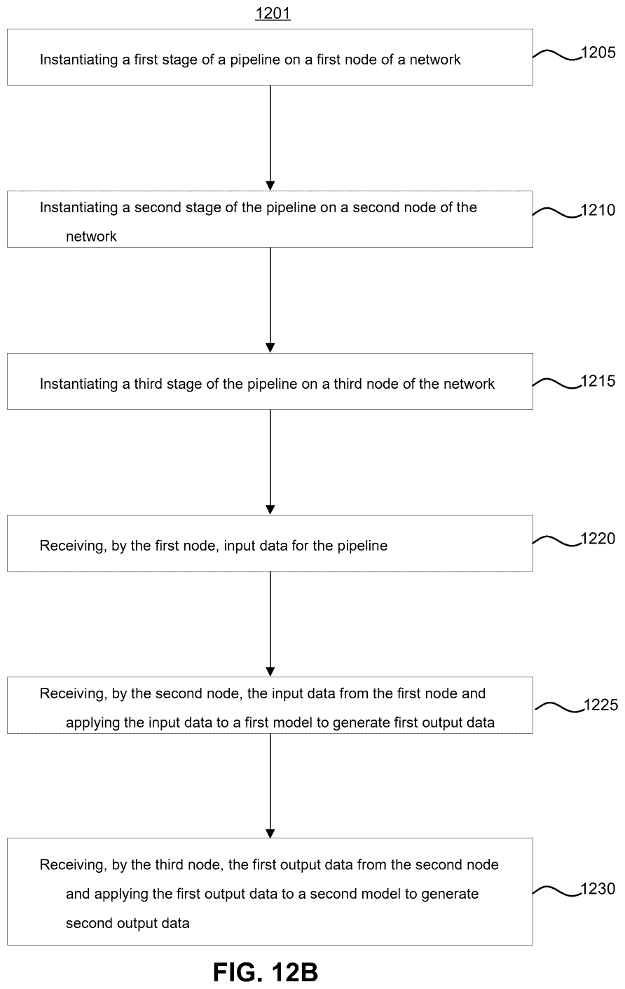

FIG. 12A is a diagram of an example network 1200 that implements the pipeline 1100 in FIG. 11, according to one or more embodiments. The network may be an ad-hoc, peer-to-peer, and/or mesh network (among other types of possible networks, such as network 170). The network 1200 includes six nodes (labeled 1-6) that implement stages 1-7 of the pipeline 1100. In some embodiments, the nodes of FIG. 12A are nodes as previously described with respect to FIGS. 1-10 (e.g., nodes 1-6 are each examples of node 110). However, this is not required. Detection models 1-5 of pipeline 1100 (also referred to simply as “models”) are stored on the nodes of network 1200, and the arrows indicate the flow of data between nodes in the network 1200 to implement the pipeline 1100. In the example of FIG. 12A, node 6 is a sage node that controls implementation and maintenance of pipeline 1100 (sage nodes are further described below). Node 6 is storing the pipeline input data, node 5 is storing model 1, node 3 is storing model 2, node 2 is storing model 3, node 1 is storing model 4, and node 4 is storing model 5. Thus, to implement pipeline 1100, the pipeline input data on node 6 is transmitted to node 5. Node 5 applies the received pipeline input data to model 1 and transmits the corresponding output data to node 3. Node 3 applies the received data to model 2 and transmits corresponding output data to nodes 2 and 1. Node 2 applies received data to model 3 and transmits the corresponding output data to node 4. Node 1 applies received data to model 4 and transmits the corresponding output data to node 4. Node 4 applies received data to model 5 to generate and store corresponding output data. For example, node 4 may display output data to a user via a GUI. In another example, the output data is stored for later (e.g., meta) analysis or sent to a queue for processing. For example, output data from a pipeline (e.g., 1100) is sent to an autonomous driving stack to control a drone's next direction change. For example, if a ship is detected to the left of the vision, the drone may turn left to maintain the ship in the center of the view.

While all data from a stage in a pipeline may be passed to the next stage, this is not required. Depending on the implementation, portions or subsets of output data from a stage may be transmitted to the next stage. For example, if a first stage includes a human detection model that processes video frames, the next stage may only receive video frames with humans detected by the human detection model and the remaining frames may be disregarded.

A stage of a pipeline may have a filtering module that determines which output data (e.g., output from a model of the current stage) is transmitted to the next stage. Additionally, or alternatively, a stage may include a filtering module that determines which input data is processed by the current stage (e.g., which data is sent to a model of the current stage). Determinations of a filtering module may be made according to logic (e.g., Boolean algebra), one or more criteria (e.g., user-defined alert criteria), one or more conditions (e.g., conditional statements), one or more detection filters, one or more alert filters (discussed below with reference to FIGS. 3-4), or some combination thereof. A detection filter is a filter (e.g., implemented by the filtering module) that determines which output data of a detection model is transmitted to the next stage of the pipeline. For example, if a stage includes a detection model, only data (e.g., images) with detections that have a threshold level of confidence may be passed to a subsequent stage (e.g., filtered) in accordance with a detection confidence filter. In another example, if a stage includes a bounding box detection model, only units of data with a bound box that meets a criterion are passed to a subsequent stage (e.g., the bounding box is above a threshold size or the bounding box overlaps with a bounding box from a model in a previous stage). Another example includes a stage with a model that analyzes geo locations relative to an area. In this example, the filtering module may be configured such that only units of data with a geo location within the area are sent to a subsequent stage in accordance with a detection location filter. Another example includes a stage with a model that analyzes whether a new or different object appears. In this example, the filtering module may be configured such that only units of data with a new or different object are sent to a subsequent stage (for example, a video feed includes ships in a view. Only a single frame of the ships is sent to a subsequent stage, while additional frames with those same ships are disregarded. However, if a new ship (not seen before) comes into view, the filtering module may send a frame that includes the new ship to a subsequent stage). In another example, the filtering module may be used to prevent the network (e.g., 1200) from being overloaded (e.g., by implementing a detection filter). For example, the filtering module can be used to limit the number of detections e.g.: (a) only the first detection transmitted to a subsequent stage or processed by the current stage, (b) rate limit (e.g. at most one data unit per second) is transmitted to a subsequent stage or processed by the current stage, (c) notify when model detections stop occurring, or (d) some combination thereof. Another example includes (a) a ship detector model and a filtering module which implements a ship detection filter that only passes images with detected ships and (b) a funnel-on-ship detector model and a filtering module which implements a funnel-on-ship detection filter that only passes images with detected ship funnels.

In a specific example, an example pipeline is configured to identify a car in images with a specific license plate alphanumeric combination. The pipeline includes a first stage with a license plate detector model (configured to identify the presence of a car license plate in an image), a second stage with an optical character recognition (OCR) model (configured to identify alphanumeric characters in an image), and a third stage with a character detection model (configured to identify a specific combination of alphanumeric characters), and the input data is a video feed of a traffic camera capturing images of a cars driving along a street. A filtering module of the first stage may be instructed to only pass video frames with detected license plates (and drop the remaining frames) in accordance with a license plate detection filter. Thus, due to the license plate detection filter of the filtering module of the first stage, the models in the second and third stages may only analyze frames with detected license plates, thus reducing the amount of data transmitted to the second and third stages. In certain embodiments, the amount of data transmitted to the second and third stages of the example pipeline may be determined based on a detection confidence filter (e.g., detections above a confidence threshold of the license plate detector model are transmitted) implemented by the filtering module of the first stage.

Accordingly, a user may set one or more detection filters that determine which output data of a detection model is transmitted to subsequent stages of the pipeline. For example, the filtering module may be instructed to (e.g., only) pass video frames meeting a first confidence threshold to a subsequent stage of the pipeline. More generally, the filtering modules enable pipelines to be bandwidth efficient by allowing subsets of the output data (as opposed to all output data) to be transmitted to subsequent stages. For example, only relevant output data from a stage is passed to a subsequent stage, while irrelevant output data is disregarded.

A stage of a pipeline may transmit data to multiple subsequent stages (this may be referred to as a fork), where the filtering module of the previous stage determines where data is transmitted to. For example, the same data from a stage is sent to multiple different stages (said differently, the same data is sent along all paths of a fork). Alternatively, the multiple subsequent stages may each receive a different (e.g., unique) set of data from the stage. For example, data frames that satisfy Condition A are transmitted to a first stage and data frames that satisfy Condition B are transmitted to a second stage. Note that FIG. 11 includes a fork between stages 3 and 4-5. Similarly, a stage of a pipeline may receive data from multiple previous stages (e.g., stage 6 of FIG. 11). If the data from the different stages should be synchronized, the data streams may be synchronized, for example, by injecting artificial latency into one or more of the streams.

A pipeline “recipe” describes a pipeline. For example, a recipe describes data to be processed in the pipeline, models in the pipeline, the order of detection models in the pipeline. For example, a recipe specifies that a set of data is input into a first detection model and output data from the first detection model is sent to a second detection model. The user may specify behaviors of one or more models of the pipeline via the pipeline recipe. A recipe may also specify instructions for filtering modules of the stages. In some embodiments, a recipe may describe an additional recipe for creating or updating a pipeline.

A pipeline recipe may be generated based on input (e.g., from a user). For example, a user may create a pipeline recipe by interacting with a graphical user interface (GUI). For example, the GUI allows a user to select data to be processed, detection models from a set of available detection models, the order of the detection models, and instructions for the filtering module of each stage. In some embodiments, the GUI allows a user to drag and drop detection models into place. Using the GUI, a user can create multiple pipeline recipes to be implemented. Among other advantages, this enables users to construct pipelines for their specific needs, desires, or use cases. Said differently, a user is not limited to only using a limited set of predetermined pipelines.

After a user creates a recipe, the pipeline may be implemented on a network by instantiating each stage. (As used herein, “instantiating” may refer to assigning nodes to stages of the pipeline, creating instances of one or more models on the assigned nodes, or a combination thereof.) A pipeline may be implemented from a recipe by a sage node.

A sage node (also “primary,” “arbiter,” or “master” node) is a node of the network that is responsible for implementing, monitoring, and maintaining a pipeline specified in a pipeline recipe. After a recipe is created, a node may be assigned to be a sage node or the node may identify that it should be a sage node (e.g., after analyzing the pipeline recipe and determining it should be the associated sage node).

A sage may be the node that has the input data for the pipeline (or is expected to have or generate the input data of the pipeline). For example, the sage is currently storing the input data or it will generate the input data (e.g., capture images via a camera). It may be advantageous to assign the node with the input data to be the sage, because, if that node isn't available, then the pipeline cannot be implemented (since the input data is unavailable). If that node isn't available, establishment of that pipeline may be delayed until that node becomes available. One or more embodiments may specify that there's only one source of data that feeds the top of any single pipeline e.g., there is a bundle of cameras and microphones, but they all feed into a single stream of multi-channel data (like an RTSP feed or MP4 file) on a single node. In other embodiments, a “Y-combiner” may run on the node with the majority of the data (e.g., by bitrate) and augment it with data streams forwarded from other nodes. If different data streams are synchronized, the data streams may be synchronized, for example, by injecting artificial latency into one or more of the streams.

Each pipeline may have a single sage node and a single node in a network may be a sage node for multiple pipelines. Among other advantages, the use of sage nodes creates a decentralized system that distributes the pipeline workload (e.g., establishing, monitoring, and maintaining pipelines) to individual nodes as opposed to a single node performing the entire workload. Furthermore, the use of sage notes avoids a single point of failure vulnerability which may arise if a single node performed the entire pipeline workload.

Based on the pipeline recipe, a sage node determines which nodes in the network can be used to implement the pipeline. More specifically, the sage node selects “minion” nodes to implement stages of a pipeline and provides appropriate instructions to those nodes. A minion (or “agent,” “operative,” or “emissary”) node is a node that can implement a stage of a pipeline. For example, minion nodes have detection models specified in the pipeline recipe. During execution of a pipeline, a minion node may receive data from the sage node or another minion node (e.g., which is implementing a previous stage of the pipeline), may apply one or more detection models stored on the node to the received data, and may transmit output data to another node of the pipeline (e.g., which is implementing a subsequent state of the pipeline). In the examples of FIGS. 1-2, node 6 is the sage node and nodes 1-5 are minion nodes to node 6. Note that a sage node may also be a minion node (e.g., if the node includes a detection model used by the pipeline).

Pipelines are not required to have a 1:1 relationship between stages and nodes. For example, a single node may host more than one stage of a pipeline (e.g., node 5 of FIG. 12A, may host both stage 2 and stage 6 of pipeline 1100). In another example, a single minion node may run multiple stages of multiple pipelines simultaneously. So a sage node may analyze the set of detection models and decide to enlist a specific node as a minion because it has multiple detection models that apply to the pipeline in question, and it may be more efficient to reduce (e.g., minimize) network traffic by keeping those stages on a single node. In some embodiments, an entire pipeline may be implemented on a single node. For example, an entire pipeline is implemented via a single node that acts as the sage and minion. A user may specify this by selecting (via the GUI) only from detection models available on a given node. That being said, a single node may still implement arbitrary length pipelines (e.g., up to the resource limits of that node).

A sage node may be aware of nodes on the network and their available resources and computational abilities via inter-network communications (e.g., prior to or subsequent to the sage node receiving the pipeline recipe). To select a minion node for a stage a pipeline, the sage node may identify a set of one or more nodes in the network that have a detection model associated with that stage and then select a node from the identified set to be a minion node. A sage node may select a node to be a minion node for a stage in a pipeline based on one or more criteria, such as: the node's location in the network, how loaded the node's CPU is, memory constraints of the node, the fullness of the hardware queue, power constraints of the node (e.g., if the node is battery or line powered, and the state of the battery), or some combination thereof. Additionally, or alternatively, it may be more memory efficient to enlist a detection model when it's already running (e.g., since the GPU may load one copy of the detection model weights, and once it's loaded, it can use that detection model in memory to detect on multiple feeds/pipelines in parallel). Thus, a sage might decide to enlist a node to apply a detection model because that node is already running that detection model for another pipeline.

If the sage node determines the network does not include enough resources to implement a pipeline (e.g., none of the nodes in the network include a detection model of the pipeline or none have enough free resources to implement the detection model of the pipeline), the sage node may delay establishment of that pipeline until the network includes enough resources to implement the pipeline.

More generally, a sage may dynamically implement, monitor, and maintain a pipeline according to the available resources of the network. For example, a sage node may delay or decommission a pipeline if the resources (e.g., needed) for that pipeline become unavailable. Similarly, the sage node may resume or restart a pipeline when the resources (e.g., needed) for that pipeline become available.

After a pipeline is implemented, the sage node may monitor the pipeline. To do this, each minion node of the pipeline may periodically provide status notifications to the sage node. A minion node may send status notifications directly to the sage node or a minion node may send status notifications upstream along the pipeline to the sage node. Among other advantages, sending status notifications upstream enables the intermediate stages to determine if there is an error condition lower in the pipeline. Even in normal operations without an error condition it may be useful to have stages add their status to the notification as it flows backwards up the pipeline, so by the time the sage receives the notification, it's a (e.g., partial or complete) set of status indications for the pipeline. In some embodiments, nodes may send notifications to other nodes in the pipeline (e.g., if a detection event occurs). For example, a GUI generated by a node may include notifications (e.g., alerts) received from a plurality of nodes.

In some embodiments, a first sage node for a first pipeline may communicate with a second sage node of a second different pipeline in the network (e.g., the first node is a minion node for the second pipeline).

If one of the nodes leaves a network (e.g., the node crashes or is moved out of range of the network) or becomes unavailable, the pipeline becomes incomplete. This results in backward pressure where the previous node is unable to transmit data to the (recently) removed node, resulting in data ceasing to move along the pipeline. In response (e.g., after a threshold number of attempts to contact the removed node), the previous node may send a notification upstream to notify the sage node of the pipeline. For example, referring to FIG. 12A, if node 2 is removed, node 3 recognizes the absence of node 2, and sends a notification to node 5. Node 5 receives the notification and forwards the notification to node 6, which is the sage node. Upon receiving the backward pressure notification, the sage node determines which node left the network and determines a new node in the network to replace the removed node. Continuing the previous example, after node 6 receives the notification from node 5, node 6 identifies a node in network 1200 (e.g., an additional node not illustrated in FIG. 12A) that has model 3 and communicates with that node to replace node 2 in the pipeline.

In some embodiments, a node remains in the pipeline but may be overloaded or occupied with higher priority tasks, creating backward pressure which triggers the sage node to rebuild the pipeline based on an updated pipeline recipe. In various embodiments, the sage node may recognize an overloaded node and instantiate one or more duplicate pipeline stages (e.g., stages with redundant instances of a model) on additional nodes to alleviate pressure on the overloaded node.

Backward pressure may be present in the pipeline even when the nodes are operating normally. For example, in the case of the pipeline 1100 of FIG. 11, stages 4 and 5 (e.g., models 3 and 4) may process data more slowly than models of the preceding stages, creating a bottleneck where generating output data of the pipeline is limited to the speed of the slowest stage. For example, the pipeline 100 may be configured to receive pipeline input data in the form of frames from a video camera at 30 frames per second. If stage 4 of the pipeline 1100 processes frames at 3 frames per second, this will apply backward pressure to stages 1 through 3. The sage node may recognize this bottleneck and instruct stages 1 through 3 to reduce their processing speed accordingly. (In some embodiments, the sage node may consolidate these bottlenecked stages/models to a common node to conserve computing resources.)

In some embodiments, nodes may implement additional or fewer models at each stage of the pipeline. In an embodiment, the pipeline may “fan out” to alleviate backward pressure or provide redundancy by implementing additional nodes, stages, and/or models for processing pipeline data in parallel. For example, the sage node may increase throughput of stage 4 by distributing model 3 across two or more minion nodes (e.g., instantiating additional copies or versions of model 3) when backward pressure over a threshold amount is detected. In an embodiment, the pipeline may “fan in” (e.g., at stage 6 of FIG. 11) where multiples models, stages, and/or nodes feed data to a common stage.

In some embodiments, the sage node may instantiate duplicate pipeline stages for reasons other than backward pressure, such as when a model of one or more stages undergoes a planned update (e.g., training, re-training, and/or replacement). For example, the sage node may instantiate a duplicate pipeline stage in anticipation of planned unavailability of one or more related pipeline stages. The sage node may temporarily modify the pipeline recipe to dynamically “swap” the duplicate pipeline stage in place of the one or more related pipeline stages, allowing data flow through the pipeline to continue uninterrupted while one or more stages are unavailable. The sage node may restore the pipeline to its original configuration when all pipeline stages are available again, such as after a model has been updated or a node has undergone maintenance. When the sage node implements the modified recipe (e.g., an updated recipe) which alters one or more nodes, stages, or models the pipeline, one or more minion nodes may implement the update while data is still being processed and transmitted through the pipeline due to redundant pipeline stages.

FIG. 12B illustrates a method 1201 of generating a dynamic processing pipeline according to a pipeline recipe. The method can include additional, fewer, or different steps than described. Additionally, the steps can be performed in a different order. The method includes instantiating 1205 a first stage of the pipeline on a first node of a network, instantiating 1210 a second stage of the pipeline on a second node of the network, instantiating 1215 a third stage of the pipeline on a third node of the network, receiving 1220, by the first node, input data for the pipeline, receiving 1225, by the second node, the input data from the first node and applying the input data to a first model to generate first output data, and receiving 1230, by the third node, the first output data from the second node and applying the first output data to a second model to generate second output data.

### Examples of Alerting Through Multiple User-Configurable Tabs

As discussed above, one or more nodes of a pipeline (e.g., any of Nodes 1-6 of the pipeline 1100) may output data to a user via a GUI. The output data may include alerts to notify the user to review object detection events from the detection model(s). In an embodiment, the output data may be final output data generated by a final node or stage of the pipeline (e.g., “pipeline output data” of the pipeline 1100 of FIG. 11). In various embodiments, the output data may be intermediate output data generated by any intermediate node or stage of the pipeline, including one or more sage nodes or minion nodes, allowing the user to preview the intermediate output data while it is being transmitted to subsequent nodes or stages of the pipeline.

Output data may include various alerts which the user does not consider relevant. As such, the user can set one or more user-defined alert filters in the GUI to selectively display a subset of the output data for their review. The GUI may be a tabbed interface supporting a plurality of alert filters, allowing the user to dynamically update filter criteria and parse different subsets of the output data. The alert filter criteria may specify particular nodes or stages (or models) of the pipeline to which the user-defined alert filter(s) are to be applied. Unlike the detection filters, which may selectively limit data transfer between various pipeline stages, the user-defined alert filters may or may not affect the data flow of the pipeline. Instead, the user-defined alert filters allow the user to dynamically control which detection events are displayed in the GUI. This may help the user to gain a more complete understanding of the output data and better evaluate pipeline performance.

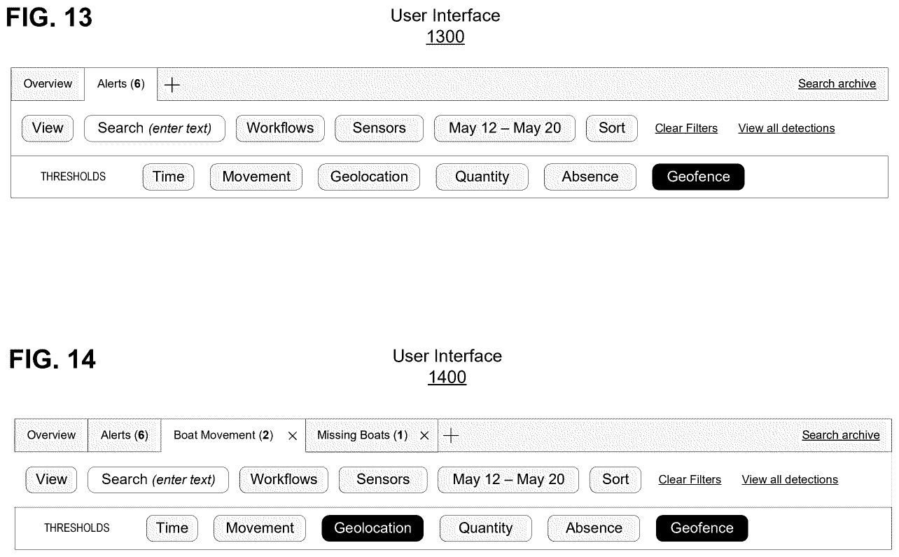

FIG. 13 is a diagram of one such GUI 1300 including a user-configurable tab for setting user-defined alert filters, according to an embodiment. FIG. 14 is a diagram of a GUI 1400 including a plurality of user-configurable tabs for setting user-defined alert filters, according to one or more embodiments. Although FIGS. 3-4 illustrate one or more user-configurable tabs, it will be understood that the GUIs further include a content pane for displaying and updating the output data based on the user-defined alert filter(s) (e.g., detections from a model). For example, the content pane may be resizable display window located below the user-configurable tab(s).

Referring now to FIG. 13, the user is presented with an “alerts” tab for displaying alerts (e.g., object detection events) from output data of one or more nodes or stages of the pipeline. (Although the GUI 1300 may display any type of alert known to those skilled in the art, the following description will refer to object detection alerts for ease of discussion.) Within the alerts tab, the user may set one or more user-defined alert filters by selecting filter criteria (a threshold being an example of a filter criterion) from a menu to determine which alerts are to be displayed (e.g., grouped) in the alerts tab and which alerts are not to be displayed (e.g., suppressed). In various embodiments, suppressed alerts may still be displayed when the user requests to view unfiltered output data of the pipeline, such as by selecting “clear filters” in the GUI 1300 which can disable any user-defined alert filters. The filter criteria may change behavior(s) of one or more models, stages, or nodes (or some combination thereof) of the pipeline via detection filter(s) implemented by the filtering module (e.g., by adjusting a confidence threshold for generating a detection alert), causing the output data to conform to the detection filter.

The GUI 1300 provides a selectable “overview” tab which may display details or settings of the pipeline related to the currently displayed alert(s) in the “alerts” tab. For example, if the “alerts” tab is displaying an object detection alert based on output data of stage 3 of the pipeline 1100, the “overview” tab may display the diagram of FIG. 11 with stage 3 distinguished to indicate it as the source of the alert. The “overview” tab may be interactive, allowing the user to adjust the pipeline structure or behavior (e.g., via a pipeline recipe) in view of the alerts displayed in the GUI 1300.

Examples of selectable filter criteria from the menu include workflows (e.g., displaying or suppressing alerts generated by specific nodes, stages, or models of the pipeline), sensors (e.g., displaying or suppressing alerts associated with specific sources of input data to the pipeline), and calendar date(s) (e.g., displaying or suppressing alerts matching a specific date or range of dates when a detection event occurred). Additional examples of selectable filter criteria include time (e.g., displaying or suppressing alerts matching a specific time or time range when a detection event occurred), movement (e.g., displaying or suppressing alerts based whether an object was determined to be stationary), geolocation (e.g., displaying or suppressing alerts based on proximity of an object to one or more reference locations), quantity (e.g., displaying or suppressing alerts based on a minimum or maximum number of detected objects), absence (e.g., displaying or suppressing alerts based on the absence of an object which may have been previously detected), and geofencing (e.g., displaying or suppressing alerts based on movement of an object across a user-defined spatial boundary). The user may specify, via the GUI 1300, that different filter criteria (e.g., higher or lower detection thresholds) are applied to different nodes, stages, or models of the pipeline. For example, a stage of the pipeline may be configured to receive two or more user-defined filter criteria from the user through the GUI 1300. The user may clear (e.g., reset) any currently applied filter criteria for the current GUI tab (e.g., the “alerts” tab) to return to displaying all object detection alerts of the output data.

The user may adjust sorting of the displayed alerts in the GUI 1300 by selecting a “sort” option. For example, the user may sort alerts by recency, detection location (e.g., proximity), or alphabetically based on alert content (e.g., an object label generated by an object detection model). The user may alternate between different views of the displayed alerts in the GUI 1300 by selecting a “view” option. Such views may include a list view (e.g., a sorted list of alerts) or a map view (e.g., the alerts plotted geographically based on detection location) in the content pane. Additionally or alternatively, the user may select a different view for the current tab by selecting a “view all detections” option, which may differ from the user's preferred view. For instance, “view all detections” may scale the map to display all detection locations simultaneously in the GUI 1300 or otherwise adjust display of the alerts to provide higher information density. The user may further narrow the displayed alerts in the GUI 1300 by entering a search query (e.g., a text string) in a search box matching one or more text fields of the output data.

In an example, the user may be an analyst tasked with monitoring security feeds of cameras in a facility. A pipeline for processing image data of the cameras may include an object detection model and a text recognition model configured to extract relevant information from the image data. An output node of the pipeline generates a GUI (e.g., the GUI 1300) to display output data including object detection alerts. The analyst may narrow the displayed object detection alerts to specific cameras (e.g., cameras located in a parking lot) by selecting the cameras from a sensors menu in the GUI. The analyst may further narrow the displayed object detection alerts to cars which have been parked for at least 48 hours by setting a time threshold and a movement threshold in the GUI. The GUI can therefore display a subset of output data requested by the analyst, such as license plate numbers of parked cars extracted by the text recognition model. The output data may be sorted automatically (e.g., by recency of a detection event) or manually according to user preference.

In an additional example, the user may be an analyst tasked with monitoring the movement of forest fires via satellite imagery. A pipeline for processing satellite image data may include one or more object detection models, such as a forest fire detection model, a vehicle detection model, and a personnel detection model configured to extract relevant information from the image data. An output node of the pipeline generates a GUI (e.g., the GUI 1300) to display output data including object detection alerts. The analyst may adjust various filter criteria via the GUI to identify new fires, monitor personnel movements, and provide feedback to fire crews as threats emerge.

In certain embodiments, the user may set a time threshold for determining object persistence (also referred to as a “strong ID”) by an object detection model. For example, the user may set a minimum time threshold of 10 seconds to prevent duplicate alerts from being generated or displayed if an object is temporarily obscured. In some cases, the time threshold may change the behavior of the object detection model to cause the model to generate fewer alerts in the future. In other cases, the time threshold does not change the behavior of the object detection model but may suppress subsequent alerts for the same type of object within the time threshold. The number of persistent objects detected by the pipeline may be used as an additional filter criterion to display an alert when, for example, the number of objects changes between one video frame and a subsequent video frame.

In various examples, a GUI can include a plurality of user-configurable tabs for setting user-defined alert filters. FIG. 14 illustrates one such GUI 1400, including three user-configurable tabs which allow the user to alternate between different views of the output data (e.g., different subsets of alerts). The user-configurable tabs may be created or deleted to assist the user in dynamically organizing and filtering alerts of the output data. The user may retrieve deleted tabs (and associated filter criteria) by selecting a “search archive” option in the GUI 1400. The user can therefore gain a more complete understanding of the output data and the performance of the pipeline by testing different alert filters (e.g., higher or lower threshold criteria) on the same data.

In the example of the GUI 1400, the user is an analyst tasked with tracking boat movements. A pipeline receives image data (e.g., satellite images) and applies an object detection model trained on images of boats to generate alerts for display in the GUI 1400 (e.g., output data). The pipeline can generate an alert any time a new boat is detected in the image data, which may be displayed in the default “alerts” GUI tab. Because the analyst is mainly interested in boat movements, he creates a new configurable tab in the GUI 1400 titled “boat movement” and applies a geolocation threshold of 1 kilometer to suppress alerts for stationary boats. The geolocation menu item in the GUI 1400 may be shaded or otherwise distinguished to indicate that a geolocation-based alert filter is currently being applied to the output data. In some cases, text of the menu item may be changed to reflect the filter criterion, e.g., “>1 km”. The analyst may define a region of interest (e.g., within 100 kilometers of the Hawaiian islands) using a geofencing threshold to further narrow the displayed alerts. The analyst may later decide that it would be advantageous to view alerts for boats which are no longer detected in the image data and creates another configurable tab in the GUI 1400 titled “missing boats”. The missing boats tab can carry over the same user-defined filter criteria from the boat movement tab, further including an absence filter configured to display only alerts for boats which have “disappeared” from the image data. The missing boats tab therefore displays a subset of the output data of the boat movement tab, allowing the analyst to parse the relevant output data more easily.

In an embodiment, the GUI 1400 may include a first GUI tab configured to display a subset of output data of the data processing pipeline system, a second GUI tab configured to display a complete set of output data of the data processing pipeline system, and an input field configured to receive a user-defined filter criterion, the user-defined filter criterion determining the subset of output data for display in the first GUI tab, wherein the complete set of output data comprises a plurality of object detection alerts, and wherein the user may interact with the first GUI tab and the second GUI tab to alternate between displaying the subset of output data and the complete set of output data.

Notably, although the user may create new alert filters or update existing ones, the alert filters may be applied retroactively to (e.g., the entirety of the) output data, enhancing the utility of the user-configurable tabs for viewing and sorting alerts. The plurality of tabs dynamically group detection alerts based on different alert filter criteria, allowing the user to change and explore different configurations without losing any data.

### Computing Machine Architecture

FIG. 15 is a block diagram illustrating components of an example machine able to read instructions from a machine-readable medium and execute them in a processor (or controller), according to one or more embodiments. Specifically, FIG. 15 shows a diagrammatic representation of a machine in the example form of a computer system 1500 within which instructions 1524 (e.g., software) for causing the machine to perform any one or more of the methodologies discussed herein may be executed (e.g., method 1201). Examples of the computer system 1500 include nodes of a pipeline, such as any of the nodes of FIG. 12A. The program code may be comprised of instructions 1524 executable by a set of one or more processors 1502. In some embodiments, the set of one or more processors 1502 includes multiple processors. In these embodiments, the processors may work individually or collectively to perform operations. In various embodiments, the machine operates as a standalone device or may be connected (e.g., networked via the network 1140 or the network 1200 of FIG. 12A) to other machines. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. In the context of a particular machine some or all the components illustrated and described with FIG. 15 may be applicable. For example, HQ 149 and any of the nodes 110 may use some or all of the components illustrated and described with FIG. 15, while a node 110 may use a substantially few components.

The machine may be, for example, a server computer, a client computer, a personal computer (PC), a tablet PC, a personal digital assistant (PDA), a cellular telephone, a smartphone, a web appliance, a network router, switch or bridge, a node or any machine capable of executing instructions 1524 (sequential or otherwise) that specify actions to be taken by that machine. Further, while only a single machine is illustrated, the term “machine” shall also be taken to include any collection of machines that individually or jointly execute instructions 1524 to perform any one or more of the methodologies discussed herein, such as those of the network 1200 of FIG. 12A.

The example computer system 1500 includes a set of one or more processors 1502 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any combination of these), a main memory 1504, and a static memory 1506, which are configured to communicate with each other via a bus 1508. The computer system 1500 may further include a visual display interface 1510. The visual display interface 1510 may include a software driver that enables displaying one or more user interfaces on one or more screens (or displays). The visual display interface 1510 may display user interfaces directly (e.g., on the screen) or indirectly on a surface, window, or the like (e.g., via a visual projection unit). For ease of discussion, the visual display interface 1510 may be described as a screen or a display panel. The visual display interface 1510 may include or may interface with a touch-enabled screen. The computer system 1500 may also include alphanumeric input device 1512 (e.g., a keyboard), a cursor control device 1514 (e.g., a mouse, a trackball, a joystick, a motion sensor, or other pointing instrument), a storage unit 1516, a signal generation device 1518 (e.g., a speaker), and a network interface device 1520, which also are configured to communicate via the bus 1508.

The storage unit 1516 includes a (e.g., non-transitory) machine-readable medium 1522 on which is stored instructions 1524 (e.g., software) embodying any one or more of the methodologies or functions described herein. The instructions 1524 (e.g., software) may also reside, completely or at least partially, within the main memory 1504 or within the processor 1502 (e.g., within a processor's cache memory) during execution thereof by the computer system 1500, the main memory 1504 and the processor 1502 also constituting machine-readable media. The instructions 1524 (e.g., software) may be transmitted or received over a network 1526 via the network interface device 1520.

While machine-readable medium 1522 is shown in an example embodiment to be a single medium, the term “machine-readable medium” should be taken to include a single medium or multiple media (e.g., a centralized or distributed database, or associated caches and servers) able to store instructions (e.g., instructions 1524). The term “machine-readable medium” shall also be taken to include any medium that is capable of storing instructions (e.g., instructions 1524) for execution by the machine and that cause the machine to perform any one or more of the methodologies disclosed herein. The term “machine-readable medium” includes, but is not limited to, data repositories in the form of solid-state memories, optical media, and magnetic media.

### Additional Configuration Considerations

The dynamic processing pipeline offers several technical benefits, particularly in the context of handling complex data processing tasks across a network of nodes. For example, by leveraging multiple models, each configured for specific tasks, the pipeline can efficiently process data in a distributed manner. This approach not only enhances the accuracy of task-specific models but also reduces the noise and error rates typically associated with general models. Additionally, the dynamic nature of the pipeline allows for real-time adjustments and optimizations, helping ensure that the most relevant and accurate data is processed and transmitted through the network. This flexibility is helpful for use cases that desire high precision and adaptability, such as image recognition, object detection, and other machine learning tasks.

The disclosed systems may provide for close to or real-time updated data of an environmental surroundings in which processing resources are limited and network communication resources are limited. The data corresponding to environmental surroundings may include information physical environment as well as contextual information about the surroundings in that physical environment. By receiving this information in close to or at real time, a user present in those surrounding now is provided information otherwise unavailable to them to help them enhance their perception capabilities within that environment. The disclosed configurations enable groups of computing devices having limited capabilities (e.g., computing resource constraints (e.g., processor, memory), network communications constraints, and/or power source constraints (e.g., battery life and/or capacity)) to pool their capabilities together to enable the execution of resource intensive tasks. The execution of resource intensive tasks may provide for each time updates with computing devices such as information on heads up displays or augmented reality overlays of real time captured video. The disclosed configurations also provide for a scheme to enable multiple mobile computing systems to communicate with each other using an unreliable network with network properties that dynamically change as each of the nodes move with respect to each other. For example, as nodes leave and enter networks, information may be dynamically updated amongst prior and new updated networks to provide new contextual information for all nodes within those respective networks.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. Code (e.g., comprising instructions) of a software module may be executable by a processor system (e.g., a set of one or more processors). A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by a set of one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The set of one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the set of one or more processors, not only residing within a single machine, but deployed across a number of machines. In some example embodiments, the set of one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A dynamic processing pipeline system implemented on nodes of a network, the processing pipeline system comprising:
a first stage on a first node of the network, the first node storing input data for the pipeline;
a second stage on a second node of the network, the second node receiving input data from the first node and applying the input data to a first object detection model to generate first detection output data; and
a third stage on a third node of the network, the third node receiving the first detection output data from the second node and applying the first detection output data to a second object detection model to generate second detection output data, the second object detection model being different than the first object detection model.

2. The dynamic processing pipeline system of claim 1, wherein the network is an ad-hoc network, a peer-to-peer network, or a mesh network, and wherein each node comprises one or more pipeline stages.

3. The dynamic processing pipeline system of claim 1, wherein the input data comprises image data.

4. The dynamic processing pipeline system of claim 1, wherein a sage node of the pipeline is configured to add or remove nodes or stages of the pipeline according to a pipeline recipe.

5. The dynamic processing pipeline system of claim 4, wherein the sage node receives notifications from the first node, the second node, or the third node of the pipeline indicating a status of the respective nodes.

6. The dynamic processing pipeline system of claim 5, wherein the sage node dynamically implements, monitors, or maintains the pipeline based on an availability of computational resources at each node as indicated by the status notifications.

7. The dynamic processing pipeline system of claim 1, further comprising a fourth stage configured to receive the second detection output data and display the second detection output data on a graphical user interface (GUI).

8. The dynamic processing pipeline system of claim 7, wherein the GUI comprises a plurality of tabs for selecting one or more user-defined filters to selectively display the second detection output data on the GUI.

9. A method of generating a dynamic processing pipeline according to a pipeline recipe, the method comprising:
instantiating a first stage of the pipeline on a first node of a network;
instantiating a second stage of the pipeline on a second node of the network;
instantiating a third stage of the pipeline on a third node of the network;
receiving, by the first node, input data for the pipeline;
receiving, by the second node, the input data from the first node and applying the input data to a first object detection model to generate first detection output data; and
receiving, by the third node, the first detection output data from the second node and applying the first detection output data to a second object detection model to generate second output data, the second object detection model being different than the first object detection model.

10. The method of claim 9, wherein the network is an ad-hoc network, a peer-to-peer network, or a mesh network, and wherein two or more of the first node, the second node, or the third node are a same node.

11. The method of claim 9, wherein the input data comprises image data.

12. The method of claim 9, wherein the first node, the second node, or the third node is a sage node of the pipeline, and wherein the sage node is configured to add or remove nodes or stages of the pipeline according to the pipeline recipe.

13. The method of claim 12, further comprising transmitting, by the first node, the second node, or the third node, notifications indicating a status of the respective node to the sage node.

14. The method of claim 13, further comprising dynamically implementing, monitoring, or maintaining, by the sage node, the pipeline based on an availability of computational resources at the first node, the second node, or the third node as indicated by the status notifications.

15. A non-transitory computer-readable storage medium comprising instructions that, when executed by one or more processors, cause the one or more processors to:
access a pipeline recipe comprising a plurality of stages of a dynamic processing pipeline;
instantiate a first stage of the pipeline on a first node of a network, the first node storing input data for the pipeline;
instantiate a second stage of the pipeline on a second node of the network, the second node receiving input data from the first node and applying the input data to a first object detection model to generate first detection output data; and
instantiate a third stage of the pipeline on a third node of the network, the third node receiving the first detection output data from the second node and applying the first detection output data to a second object detection model to generate second detection output data, the second object detection model being different than the first object detection model.

16. The computer-readable storage medium of claim 15, wherein the network is an ad-hoc network, a peer-to-peer network, or a mesh network, and wherein two or more of the first node, the second node, or the third node are a same node.

17. The computer-readable storage medium of claim 15, wherein the input data comprises image data.

18. The computer-readable storage medium of claim 15, wherein the first node, the second node, or the third node is a sage node of the pipeline, and wherein the sage node is configured to add or remove nodes or stages of the pipeline according to the pipeline recipe.

19. The computer-readable storage medium of claim 18, wherein the sage node receives notifications from the first node, the second node, or the third node of the pipeline indicating a status of the respective nodes.

20. The computer-readable storage medium of claim 19, wherein the sage node dynamically implements, monitors, or maintains the pipeline based on an availability of computational resources at each node as indicated by the status notifications.
